(19) United States
(12) Patent Application Publication
(10) Pub. No.: US 2023/0388259 A1
(43) Pub. Date: Nov. 30, 2023

(54) MULTIMEDIA INTERACTION

(71) Applicant: Tencent Technology (Shenzhen) Company Limited, Shenzhen (CN)

(72) Inventor: Yanqing FENG, Shenzhen (CN)

(73) Assignee: Tencent Technology (Shenzhen) Company Limited, Shenzhen (CN)

(21) Appl. No.: 18/447,120

(22) Filed: Aug. 9, 2023

Related U.S. Application Data
(63) Continuation of application No. PCT/CN2022/111245, filed on Aug. 9, 2022.

(30) Foreign Application Priority Data
Sep. 16, 2021 (CN) 202111085744.4

(51) Int. Cl. H04L 51/10; H04L 51/043; H04L 51/02

(52) U.S. Cl. CPC H04L 51/10; H04L 51/043; H04L 51/02

(57) ABSTRACT

Some aspects of the disclosure provide a method of multimedia interaction. The method includes displaying, by a first terminal device that is an invitation terminal device for a multimedia acquisition, a condition configuration interface of an application that is logged in into a first account, the condition configuration interface includes condition configuration options. The method further includes determining an acquisition condition for acquiring a multimedia content in response to a configuration operation performed on the condition configuration options in the condition configuration interface, displaying at least one candidate account that matches the acquisition condition and transmitting an interaction message to a second account in response to a selection operation performed on the second account in the at least one candidate account. The interaction message indicates an invitation from the first account to the second account to acquire the multimedia content.

### RELATED APPLICATIONS

The present application is a continuation of International Application No. PCT/CN2022/111245, filed on Aug. 9, 2022 and entitled “MULTIMEDIA INTERACTION METHOD, SYSTEM AND APPARATUS, AND DEVICE, MEDIUM AND COMPUTER PROGRAM”, which claims priority to Chinese Patent Application No. 202111085744.4, filed on Sep. 16, 2021 and entitled “MULTIMEDIA INTERACTION METHODS, SYSTEM AND APPARATUSES, DEVICE, MEDIUM AND COMPUTER PROGRAM”. The entire disclosures of the prior applications are hereby incorporated by reference in their entirety.

### FIELD OF THE TECHNOLOGY

Embodiments of this disclosure relate to the field of computer technologies, including multimedia interaction methods and apparatuses, a multimedia interaction system, a device, a medium and a computer program.

### BACKGROUND OF THE DISCLOSURE

Multimedia content involves many industries because of its three-dimensional, lively and diversified features. Recording multimedia also becomes a common form of entertainment for users. Users often record multimedia by using electronic devices, and share the recorded multimedia to friends and the public through a network platform.

In the relevant technologies, multimedia contents are usually recorded by means of an intelligent device, a camera or a video recorder, then imported into editing software for processing, and posted. Or, existing multimedia are imported into the editing software for processing and then posted, to achieve a multimedia interaction process.

However, when multimedia interaction is performed in the above-mentioned manner, a photographer is often limited by a certain geographical location or device conditions, so that an obtained multimedia content cannot meet requirements.

### SUMMARY

Embodiments of this disclosure provide multimedia interaction methods and apparatuses, a multimedia interaction system, a device, a medium and a computer program, which can improve the convenience of obtaining multimedia contents under a specified condition by users and improve the obtaining efficiency of multimedia contents.

Some aspects of the disclosure provide a method of multimedia interaction. The method includes displaying, by a first terminal device that is an invitation terminal device for a multimedia acquisition, a condition configuration interface of an application that is logged in into a first account, the condition configuration interface includes condition configuration options. The method further includes determining an acquisition condition for acquiring a multimedia content in response to a configuration operation performed on the condition configuration options in the condition configuration interface, displaying at least one candidate account that matches the acquisition condition and transmitting an interaction message to a second account in response to a selection operation performed on the second account in the at least one candidate account. The interaction message indicates an invitation from the first account to the second account to acquire the multimedia content.

Some aspects of the disclosure provide a method of multimedia interaction that includes receiving, by a terminal device that is an executive terminal device for a multimedia acquisition, an interaction message transmitted by a first account. The interaction message includes acquisition conditions configured by the first account for an invitation to acquire a multimedia content, and the terminal device is logged in into a second account that satisfies the acquisition conditions. The method also includes transmitting a feedback message to the first account in response to a trigger operation performed on the interaction message, the feedback message indicates an interaction response of the second account to the invitation to acquire the multimedia content.

Some aspects of the disclosure also provide an apparatus that includes processing circuitry. The processing circuitry is configured to display a condition configuration interface of an application that is logged in into a first account, the condition configuration interface includes condition configuration options. The processing circuitry is further configured to determine an acquisition condition for acquiring a multimedia content in response to a configuration operation performed on the condition configuration options in the condition configuration interface, display at least one candidate account that matches the acquisition condition, and transmit an interaction message to a second account in response to a selection operation performed on the second account in the at least one candidate account. The interaction message indicates an invitation from the first account to the second account to acquire the multimedia content.

Beneficial effects of the technical solutions provided by the embodiments of this disclosure can at least include:

The first account configures the acquisition conditions in the condition configuration interface, so that a server selects, according to the acquisition conditions, candidate accounts satisfying the acquisition conditions; the first account selects and obtains the second account on the basis of the at least one candidate account, and transmits the interaction message to the second account, thereby realizing a multimedia interaction process of acquiring a multimedia content via the second account. In this way, the first account can break through the limitations of acquisition conditions, such as a recording capability of a device and a geographical location, and more quickly and effectively obtain multimedia contents satisfying the acquisition conditions.

### BRIEF DESCRIPTION OF THE DRAWINGS

FIG. 1 is a schematic diagram of an environment of a multimedia interaction method provided according to an exemplary embodiment of this disclosure.

FIG. 2 is a flow diagram of a multimedia interaction method provided according to one exemplary embodiment of this disclosure.

FIG. 3 is a flow diagram of a multimedia interaction method provided according to another exemplary embodiment of this disclosure.

FIG. 4 is a flow diagram of a multimedia interaction method provided according to another exemplary embodiment of this disclosure.

FIG. 5 is a schematic diagram of an interface of an invitation accept message provided according to another exemplary embodiment of this disclosure.

FIG. 6 is a flow diagram of a multimedia interaction method provided according to another exemplary embodiment of this disclosure.

FIG. 7 is a flow diagram of a multimedia interaction method provided according to another exemplary embodiment of this disclosure.

FIG. 8 is a schematic diagram of an interface of an inviter provided according to another exemplary embodiment of this disclosure.

FIG. 9 is a schematic diagram of an interface of a photographer provided according to another exemplary embodiment of this disclosure.

FIG. 10 is an overall flow diagram provided according to another exemplary embodiment of this disclosure.

FIG. 11 is a flow diagram of a multimedia interaction system provided according to one exemplary embodiment of this disclosure.

FIG. 12 is a structural block diagram of a multimedia interaction apparatus provided according to one exemplary embodiment of this disclosure.

FIG. 13 is a structural block diagram of a multimedia interaction apparatus provided according to another exemplary embodiment of this disclosure.

FIG. 14 is a structural block diagram of a multimedia interaction apparatus provided according to another exemplary embodiment of this disclosure.

FIG. 15 is a structural block diagram of a terminal according to one exemplary embodiment of this disclosure.

### DESCRIPTION OF EMBODIMENTS

In related technologies, multimedia contents are usually recorded by means of an intelligent device, a camera or a video recorder, then imported into editing software for processing, and posted. Or, existing multimedia are imported into the editing software for processing and then posted, to achieve a multimedia interaction process.

However, when multimedia interaction is performed in the above-mentioned manner, a photographer is often limited by a certain geographical location or device conditions, so that an obtained multimedia content cannot meet requirements.

In embodiments of this disclosure, a multimedia interaction method is provided, so that a user can break through the limitations of acquisition conditions, such as a recording capability of a device and a geographical location, to obtain, if the device of the user does not satisfy the acquisition conditions, multimedia contents satisfying the acquisition conditions, thereby completing a multimedia interaction process. For example, the multimedia interaction method described in this disclosure can be applied to at least one of the following scenes.

First, the multimedia interaction method can be applied to a case where there is no acquisition device.

In an example, a certain scene needs to be photographed using a professional photographing device. However, the device quality available in the first account cannot meet a photographing requirement, and it is not cost-effective to purchase a professional photographing device separately for one photographing process. At this time, acquisition conditions required by a professional device are configured and uploaded to a server. The server searches for accounts satisfying the acquisition conditions and forms a candidate account list. The first account selects a satisfactory second account from the candidate account list. The server transmits an interaction message to the second account. Then, photographing is performed on the basis of the determination of the second account on the interaction. After the photographing process is finished, the first account obtains a multimedia content, and the multimedia content satisfies the acquisition conditions, so that a high-quality multimedia content can still be obtained when the first account does not have a professional photographing device, thereby completing multimedia interaction.

Second, the multimedia interaction method can be applied to a case where acquisition materials need to be obtained in time.

In an example, for a specified scene at a far distance, there is a need to obtain relevant information of the specified scene as quickly as possible. However, the first account is not in the specified scene and cannot reach the scene within a short time. At this time, the first account can selectively configure acquisition conditions of currently being the specified scene or being about to reach the specified scene, and upload the acquisition conditions to a server. The server searches for accounts satisfying the acquisition conditions and forms a candidate account list. The first account selects a satisfactory second account from the candidate account list. The server transmits an interaction message to the second account. Then, photographing is performed on the basis of the determination of the second account on the interaction. After the photographing process is finished, the first account obtains a multimedia content, and the multimedia content satisfies the acquisition conditions, so that relevant information of the specified scene can still be obtained when the first account is not in the specified scene, thereby completing multimedia interaction.

The above application scenarios are merely illustrative examples, and the multimedia interaction method provided by this embodiment can also be applied to other scenarios. Embodiment of this disclosure are not limited to the examples above.

Next, an implementation environment involved in this embodiment of this disclosure will be described. Referring to FIG. 1, the implementation environment involves an invitation terminal 110, a server 120 and an executive terminal 130. The invitation terminal 110, the executive terminal 130 and the server 120 are connected via a communication network 140.

In some embodiments, the invitation terminal 110 is configured to transmit a multimedia interaction request to the server 120. The multimedia interaction request includes acquisition conditions configured by a first account. In some examples, the invitation terminal 110 can realize an acquisition condition configuration function. A condition configuration interface exists in the invitation terminal 110. The acquisition conditions configured by the first account can be determined on the basis of configuring condition configuration options in the condition configuration interface, and the first account is an account for logging in the condition configuration interface.

The server 120 receives, on the basis that the first account completes a configuration operation performed on the condition configuration options, a multimedia interaction message transmitted by the invitation terminal 110, and a candidate account list is displayed on the invitation terminal 110. At least one candidate account in the candidate account list satisfies the acquisition conditions. The first account selects a second account from the candidate account list, and the server 120 transmits an interaction message to the executive terminal 130 via the communication network 140, and requests the second account logging in to the executive terminal 130 to assist in inviting the first account logging in to the invitation terminal 110 to complete acquisition of a multimedia content, to realize multimedia interaction.

The above terminal may be implemented as a mobile terminal such as a mobile phone, a tablet computer, a portable laptop computer and a vehicle-mounted terminal, or a desktop computer. The above server may be an independent physical server, or may be a server cluster or a distributed system formed by a plurality of physical servers, or may be a cloud server that provides basic cloud computing services such as cloud services, cloud databases, cloud computing, cloud functions, cloud storage, network services, cloud communication, middleware services, domain name services, security services, Content Delivery Networks (CDNs), big data, and artificial intelligence platforms.

A cloud technology is a hosting technology for unifying a series of resources such as hardware, application programs, and networks in a wide area network or a local area network to achieve computation, storage, processing and sharing of data.

In some embodiments, the above server may also be implemented as a node in a blockchain system. A blockchain is a novel application mode of computer technologies such as distributed data storage, peer to peer transmission, a consensus mechanism, and an encryption algorithm.

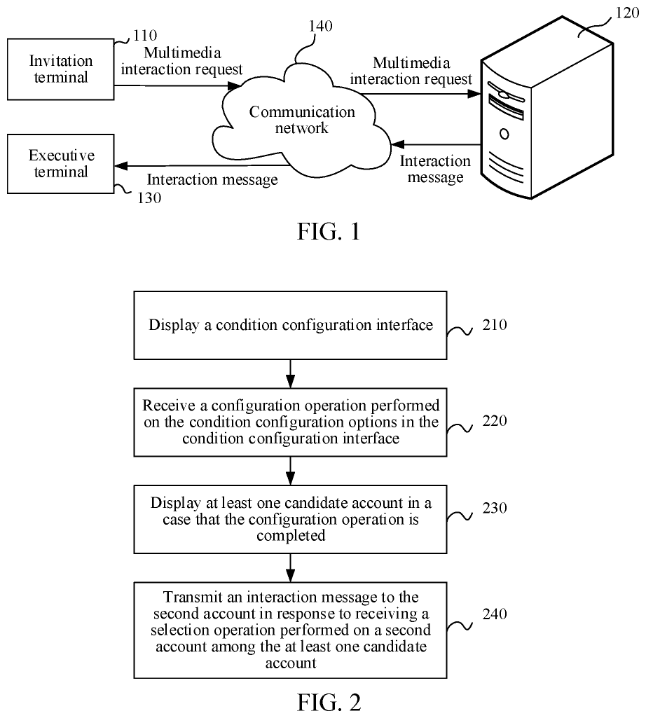

FIG. 2 is a flow diagram of a multimedia interaction method provided according to one exemplary embodiment of this disclosure. An example in which method is applied to an invitation terminal is taken for description. As shown in FIG. 2, the method includes steps that will be described in further detail.

In step 210, a condition configuration interface is displayed.

The condition configuration interface includes condition configuration options, and the condition configuration interface is logged in with a first account.

In some examples, the condition configuration interface includes at least the following display manners:
1. A condition configuration interface in an application program. For example, an application program has a multimedia interaction function. In a realizing process of the multimedia interaction function, the condition configuration interface is first displayed. A condition configuration function is triggered when the application program is opened, to display the condition configuration interface. Or, a control corresponding to a condition configuration function is triggered after the application program is opened, thereby displaying the condition configuration interface. It is also possible to set a preset operation on the control (for example, performing a long-press operation on an icon), to trigger the condition configuration function, thereby displaying the condition configuration interface. In some examples, the application program includes at least one of an instant messaging application program, a short video social application program, a multimedia playing application program and the like, and this embodiment does not limit this.
2. A self-contained condition configuration interface on a terminal. For example, an operating system of a mobile terminal (for example, a mobile phone) has a multimedia interaction function during delivery configuration.

The above interfaces are merely illustrative examples, and do not limit the scope of the present disclosure.

In some examples, the condition configuration interface is logged in with a first account. When the condition configuration interface is the condition configuration interface in the application program, the first account can be an account logging in to the application program. When the condition configuration interface is the self-contained condition configuration interface on the terminal, the first account may be an account logging in to a system of the terminal.

The condition configuration options are used for configuring acquisition conditions for acquiring a multimedia content, namely, acquisition conditions are determined through the condition configuration options. The condition configuration options include at least a title configuration option, a resource exchange condition configuration option, a remark configuration option, a device configuration option, a geographical location configuration option, a time configuration option, and a qualification configuration option. Different acquisition conditions, namely, scopes of the acquisition conditions, can be distinguished according to the different condition configuration options.

In an embodiment, the condition configuration interface includes at least two condition configuration options. The at least two configuration options are displayed in the condition configuration interface in at least the following ways:
1. The at least two condition configuration options are displayed in a tiled and parallel manner in the condition configuration interface.

The tiled and parallel display manner means that at least two condition configuration options do not overlap with each other on the condition configuration interface, and are sequentially arranged from top to bottom or from left to right. For example, there are two condition configuration options in the condition configuration interface, and the two condition configuration options are sequentially arranged at a center position of the condition configuration interface in an upper-lower arrangement manner without overlapping. That is, by the tiled and parallel display manner, an inviter can quickly know configuring which conditions to screen candidate accounts, to improve the condition configuration efficiency.
2. The at least two condition configuration options are switched to be displayed correspondingly for at least two tabs in the condition configuration interface.

A tab refers to a manner in which contents on the condition configuration interface are displayed by scrolling, sliding, expanding and the like. For example, there are two condition configuration options on the condition configuration interface. Each condition configuration option is located on a tab of the condition configuration interface. When a configuration operation of one condition configuration option is completed, the next tab can be displayed by sliding, scrolling and the like, or the next tab can be displayed automatically by sliding, scrolling and the like in response to the completion of the configuration operation, to perform a configuration operation on the condition configuration option on the second tab. That is, when the condition configuration options are displayed in the form of tab switching, the single condition configuration option has a sufficient display region for displaying a detailed content of the condition configuration option, which ensures the accuracy of configuring the condition configuration option by the inviter.

In an embodiment, there are lots of acquisition conditions in a wide range, and the acquisition conditions for acquiring a multimedia content can be configured by the acquisition condition configuration options. For example, the acquisition conditions include at least: a type condition of a multimedia content; an acquisition manner condition and an acquisition executive condition of a multimedia content; and a device condition for acquiring a multimedia content, and the like.

A multimedia content includes at least one of an audio content, an image content, a video content, and other media forms. For a process of acquiring a multimedia content, namely, obtaining a multimedia content, In some examples, a multimedia content is acquired in at least one of the following manners.
1. An audio content is recorded. For example, for sounds (namely, music, white noise, and noise), an audio content can be captured using a microphone, a recording pen and other audio inputting devices, to achieve acquisition of the audio content.
2. An image/video is photographed. For example, for a video content (namely, a short video and a video material) or an image content, a video/image content can be captured using a camera, a mobile phone camera, a digital single lens reflex and other image inputting devices, to achieve acquisition of the video content/image content.
3. An editing synthesis manner is used. For example, recutting, adding of special effects and adjustment of brightness are performed on multimedia contents such as a sound content, an image content and a video content. Or, based on existing images and videos, texts, background music, and the like are added to the existing images and videos. The existing images and videos not only include images and videos which have already existed in other people's devices before acquiring a multimedia content, but also include images and videos which are acquired and uploaded by other people during acquiring a multimedia content, but are not presented in an open form on a network. Or, a plurality of pictures or sounds are cut and then synthesized. The above manners can all update an original multimedia content, so as to acquire an updated multimedia content.

The above manners for acquiring a multimedia content are merely examples, and do not limit the scope of this disclosure.

In step 220, a configuration operation performed on the condition configuration options in the condition configuration interface is received.

In an embodiment, the condition configuration options include condition keywords and filling boxes. For a filling box corresponding to the condition keyword, a filling operation, as the configuration operation, performed on the filling box is received.

The condition keyword can be a keyword of a category to which the acquisition condition belongs. If the acquisition condition is the type of a photographing device, the condition keyword can be “type”. Or, the condition keyword can be a keyword of a content involved in the acquisition condition. If the acquisition condition is a geographical location, and the condition keyword can be “map”. Or, the condition keyword can be an abstract summary of the acquisition condition. For example, if the acquisition condition is a resource exchange condition, the condition keyword may be “reward”.

Different condition keywords represent different acquisition conditions, and correspond to different filling boxes. In some examples, one condition keyword corresponds to at least one filling box, and the filling box is used for configuring at least one acquisition condition. A filling box exists in at least one of the following manners.
1. A filling box exists as an option. For example, the filling box can exist as an option directly on a page, or as a drop-down bar can exist on a side, and the acquisition condition can be displayed in a spread manner by clicking the drop-down bar. Then, a selection operation can be performed on the acquisition condition by clicking or pressing the acquisition condition in the filling box or triggering the acquisition condition in other ways. In addition, when the at least one acquisition condition in one filling box is selected, only one acquisition condition may be selected, or two, three, or more acquisition conditions may be selected sequentially or simultaneously. Or, the filling box may be skipped, to not select the acquisition conditions corresponding to the condition keyword.
2. A filling box exists as an input. For example, the filling box is a text input box or a voice input box. A corresponding text input function or voice input function is triggered by performing operations such as clicking, pressing and voice on the filling box, or text inputting and voice inputting can be randomly switched.
3. A filling box exists in a spread manner. For example, the filling box is a link or a control. The link or the control is triggered to jump to a condition presentation interface, and an acquisition condition on the condition presentation interface is clicked to be selected.

The above interfaces are merely illustrative examples, and this embodiment of this disclosure does not limit this.

In some examples, the condition configuration options are composed of the above condition keywords and filling boxes, and acquisition conditions are configured through the condition configuration options, to determine the acquisition conditions. In some examples, the condition configuration options include at least one of a title configuration option, a resource exchange condition configuration option, a remark configuration option, a device configuration option, a geographical location configuration option, a time configuration option, and a qualification configuration option.

The device configuration option is used for indicating a device acquisition condition for acquiring a multimedia content acquisition. The geographical location configuration option is used for indicating a geographical location acquisition condition for acquiring a multimedia content. The time configuration option is used for indicating a time range condition for acquiring a multimedia content. The qualification configuration option is used for indicating a qualification condition of an executive party for acquiring a multimedia content.

In an embodiment, the condition configuration options include the title configuration option.

In some examples, a keyword of the title configuration option is “title”; the filling box is a filling box of a text input form; and contents of the filling box are self-defined. The keyword “title” is used for indicating general descriptions of an acquisition condition, an acquisition method, and the like for the multimedia content. The general descriptions of the acquisition conditions, an acquisition content and the like can be input to the filling box, or more attractive words can be used to describe the title content. In an example, the filling box of title may limit a text input form. For example, only Chinese characters can be entered; both English characters and Chinese characters can be entered; Chinese, English and special characters can be entered; and the like. In addition, the filling box of title may be preset with a word number limit. When a text content in the filling box reaches the preset word number limit, a prompt of “No more characters can be entered” or a prompt of “30/30” (which means the word number reaches the word number limit of 30 words) is displayed. In an example, when “Help to acquire a morning bird call” is entered in the filling box of title, the content of the filling box will be Displayed as a title.

In an embodiment, the condition configuration options include the remark configuration option.

In some examples, a keyword of the remark configuration option is “explanation”; the filling box is a filling box of a text input form; and contents of the filling box are self-defined. The keyword “explanation” is used for indicating descriptions of an acquisition condition, an acquisition precaution, a key point of acquisition, and the like for the multimedia content. Specific contents that describe the acquisition condition, the acquisition precautions, and the key point of acquisition can be input to the filling box, or the filling box may not be filled. In an example, the filling box of remarks may be preset with a word number limit. When a text content in the filling box reaches the preset word number limit, a prompt of “No more characters can be entered” or a prompt of “200/200” (which means the word number reaches the word number limit of 200 words) is displayed.

In an embodiment, the condition configuration options include the resource exchange configuration option.

The resource exchange configuration option is used for indicating a resource exchange condition selectively set by the inviter during the acquisition of the multimedia content. The resource exchange condition can be regarded as an incentive measure, and the inviter searches for an executive party satisfying the acquisition condition by setting the resource exchange condition. Exchange contents of the resource exchange condition include: props, virtual currency, points, and the like.

With regard to the filling box corresponding to a resource exchange configuration option, a filling operation performed on the filling box at least includes the following manners.
1. Content editing manner. For example, the inviter is free to choose to set the number of virtual coins, for example: 10 virtual coins and 26 virtual coins.
2. Content selection manner. For example, the resource exchange condition is a condition agreement manner. A condition agreement is a task set by a system and that the inviter can do. The inviter selects the resource exchange condition set by the system. For example, the inviter agrees to cooperate with the executive party to take a short video of 1 minute after 5 days according to a wish of the executive party.

The above interfaces are merely illustrative examples, and do not limit the scope of this disclosure. That is, the inviter can set acquisition conditions for a desired multimedia content by providing a plurality of condition configuration options, so as to facilitate the server to screen accounts with a finer granularity, thereby determining candidate accounts which is more in line with the requirement of the inviter, and improving the effectiveness of multimedia interaction.

In step 230, at least one candidate account is displayed when the configuration operation is completed.

The at least one candidate account being an account matching a configured acquisition condition. In some examples, the at least one candidate account may be displayed through a candidate account list.

The acquisition condition is a limiting condition for the candidate accounts. When the configuration operation is completed, the configured acquisition condition is determined thereby. When an account satisfies the configured acquisition condition, the account is used as a candidate account.

In some examples, the candidate account list is displayed in at least the following manners:
1. The candidate account list includes all candidate accounts that satisfy the acquisition condition.

In an example, after it is determined that the account satisfies the configured acquisition condition, at least one account satisfying the configured acquisition condition is used as a candidate account, and all the candidate accounts are listed in the candidate account list.
2. The candidate account list includes partial candidate accounts that satisfy the acquisition condition.

For example, after it is determined that the account satisfies the configured acquisition condition, at least one account satisfying the configuration is used as a candidate account; a multimedia interaction request is automatically transmitted to the at least one candidate account; and the remaining candidate accounts are listed in the candidate account list.

In an embodiment, a multimedia interaction request is transmitted to a server in response to the completion of the configuration operation; the at least one candidate account fed back by the server on the basis of the acquisition condition is received; and a candidate account list including the at least one candidate account is displayed.

The multimedia interaction request includes the acquisition condition.

In some examples, the acquisition condition is automatically determined after the configuration operation is completed, or the inviter triggers a condition determining function to determine the acquisition condition after the configuration operation is completed. Later, the acquisition condition is transmitted to the server in the form of a multimedia interaction request, and the server searches, according to the acquisition condition, for an executive party satisfying the acquisition condition. For example, the inviter transmits a multimedia interaction message to the server via an application program, and the server searches for an executive party satisfying the condition in at least the following ways:
1. The server determines in real time an executive party satisfying the acquisition condition in a current application program. For example, after receiving the multimedia interaction request, the server queries, according to the acquisition condition in the application program in real time, accounts logged in to the application program for the executive party satisfying the acquisition condition.
2. The server periodically receives account information. For example: a terminal reports the account information to the server once every 10 minutes. When receiving the multimedia interaction request, the server determines, on the basis of the multimedia interaction request, whether the account information satisfies the acquisition condition. In an example, the account information includes age information, geographical location information, qualification condition information, and the like. After receiving the multimedia interaction information, the server queries the existing account information for the executive party satisfying the acquisition condition.

In some examples, after finding the executive party satisfying the acquisition condition, the server transmits at least one piece of executive party information, namely, at least one candidate account, satisfying the acquisition condition to a terminal (for example, a mobile phone) logged in by the inviter, and forms the candidate account list on the basis of the at least one candidate account.

That is, the server determines the candidate accounts from a plurality of accounts through the multimedia interaction request transmitted by the invitation terminal, so that the invitation terminal can display the corresponding account list on the basis of the candidate accounts, facilitating the inviter to clearly obtain statuses of the candidate accounts that can be selected. At the same time, in a case of a large number of candidate accounts, part of the candidate accounts which satisfy the acquisition condition are displayed, to reduce a data volume during the transmission of the account information by the server to the invitation terminal, thereby reducing the consumption of transmission resources.

In step 240, an interaction message is transmitted to the second account in response to receiving a selection operation performed on a second account among the at least one candidate account.

The interaction message is a message indicating that the first account invites the second account to acquire the multimedia content. The interaction message is used for instructing the second account to perform multimedia acquisition interaction with the first account.

In an embodiment, a feedback message of the second account is displayed after the interaction message is transmitted to the second account.

The feedback message includes at least one of an invitation accept message or an invitation reject message, and the feedback message is result feedback that the first account invites second account to perform the multimedia content acquisition on the basis of the acquisition condition.

The invitation accept message is used for indicating that the second account accepts the invitation to acquire a multimedia content, and the invitation reject message is used for indicating that the second account rejects the invitation to acquire a multimedia content.

The first account is an account logging in to the condition configuration interface, and the second account is an account which satisfies the acquisition condition and is selected by the inviter. For example, the first account is the inviter. The first account performs a selection operation on the second account on the basis of the candidate account list, transmits the interaction message to the second account, and requests, on the basis of the acquisition condition according to an intention of the first account, the second account to photograph scenic spot A. The interaction message is a message generated by selecting the second account on the basis of the first account. The terminal logged in with the first account displays the feedback message of the second account on the basis of the operation of the second account performed on the interaction message. The feedback message includes at least several following cases.
1. The invitation accept message is displayed in response to an accept operation of the second account performed on the interaction message.

The accept operation is used for instructing the second account to accept the interaction message, and the invitation accept message is used for indicating that the second account accepts the invitation to acquire a multimedia content. For example, after the first account transmits the interaction message to the second account via the server, the second account chooses to accept the interaction message, namely, the second account decides to assist in the interaction message transmitted by the first account. In some examples, in order to avoid multiple persons from simultaneously accepting the interaction message, the server temporarily binds a task corresponding to the acquisition condition to the second account on the basis of the acceptance of the second account, confirms the currently bound second account again on the basis of the acquisition condition, and determines whether the bound second account satisfies the acquisition condition. In an example, when the acquisition condition is a geographical location acquisition condition, the server focuses on selecting a region with a larger territorial scope, such as within 5 kilometers, during the selection of candidate accounts; and after the second account is bound to the task corresponding to the acquisition condition, the server determines a territorial scope of the second account again, to correspondingly narrow the determined territorial scope, such as within 1 kilometer. Or, when the first account configures the acquisition condition, at least one acquisition condition is selected as a mandatory acquisition condition; and when the currently bound second account is confirmed, whether the second account satisfies the acquisition condition is determined according to the mandatory acquisition condition. When the second account accepts the interaction message and still satisfies the acquisition condition after reconfirmation, the server transmits the invitation accept message to the first account on the basis of the confirmation of the interaction message by the second account, and the terminal logged in with the first account displays the invitation accept message.
2. The invitation reject message is displayed in response to a reject operation of the second account performed on the interaction message.

The reject operation is used for instructing the second account to reject the interaction message. In an example, the second account receives the interaction message after the first account transmits the interaction message to the second account via the server. However, the second account chooses to refuse to accept the interaction message because of time, a resource exchange condition or other personal reasons, namely, the second account does not assist in the interaction message transmitted by the first account. In response to receiving the reject operation of the second account performed on the interaction message, the server no longer transmits the interaction message to the second account, namely, the second account will no longer receive the interaction message. Meanwhile, the server transmits the invitation reject message to the first account, and the terminal logged in with the first account displays the invitation reject message, so that the first account knows that the second account cannot interact with the first account. The first account may search, on the basis of the invitation refusal message, for other second accounts satisfying the acquisition condition and continue to transmit the interaction message to another second account.
3. An invitation failure message is displayed in response to that no confirm operation or reject operation of the second account is received within a preset duration.

For example, the second account does not perform a confirm or reject operation on the interaction message within a preset duration after the first account transmits the interaction message to the second account via the server, so that the server cannot receive the confirm or reject operation of the second account performed on the interaction message. The server transmits the invitation failure message to the first account on the basis that time for waiting the second account to make a response reaches the preset duration, and the terminal logged in with the first account displays the invitation failure message, so that the first account knows that the second account cannot interact with the first account. The first account can search, on the basis of the invitation reject message, for other second accounts satisfying the acquisition condition, and continue to transmit the interaction message to another second account.

That is, the feedback message of the second account for the interaction message is displayed, so that the inviter can determine whether the second account accepts the interaction message, and the inviter determines whether to reselect a second account or to execute a subsequent multimedia content interaction process, which improves the interaction efficiency of the overall multimedia interaction.

In summary, in the method provided by this embodiment, the first account configures the acquisition conditions in the condition configuration interface, so that a server selects, according to the acquisition conditions, candidate accounts satisfying the acquisition conditions; the first account selects and obtains the second account on the basis of the at least one candidate account, and transmits the interaction message to the second account, thereby realizing a multimedia interaction process of acquiring a multimedia content via the second account. In this way, the first account can break through the limitations of acquisition conditions, such as a recording capability of a device and a geographical location, and more quickly and effectively obtain multimedia contents satisfying the acquisition conditions.

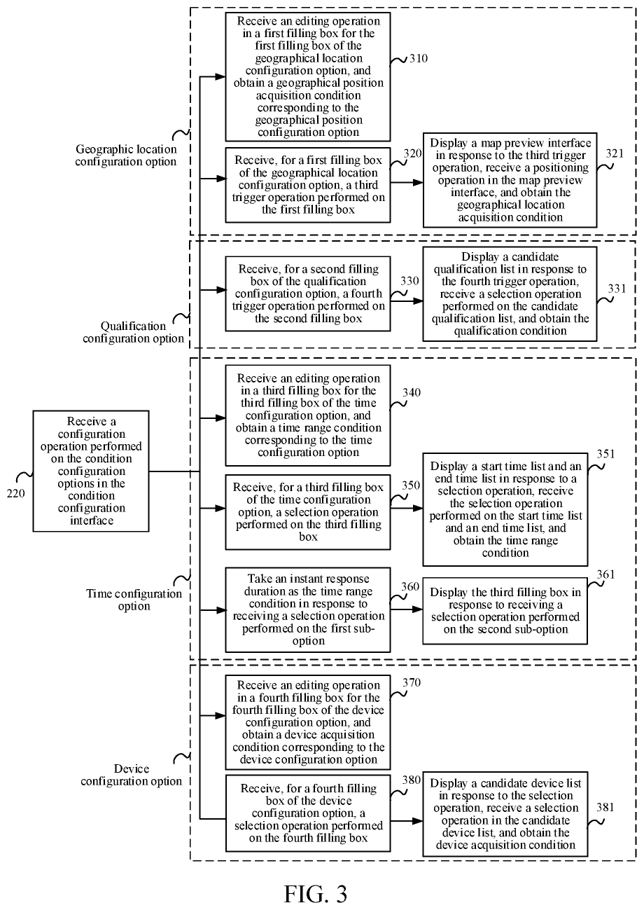

In an embodiment, at least one condition configuration option is included in the condition configuration interface. The condition configuration options include at least one of: (1) a device configuration option; (2) a geographical location configuration option; (3) a time configuration option; and (4) a qualification configuration option. The above condition configuration options are described separately. As shown in FIG. 3, the condition configuration options in the above step 220 can be implemented as the following Step 310 to Step 381.

(1) Geographic Location Configuration Option

With regard to a filling box corresponding to the geographical location configuration option, a filling operation performed on the filling box at least includes the following steps:

In step 310, an editing operation in a first filling box for the first filling box of the geographical location configuration option is received, and a geographical location acquisition condition corresponding to the geographical location configuration option is obtained.

The editing operation is to edit a content of the first filling box, and content information to which the first filling box can respond is an acquisition condition related to a geographical location condition.

For example, the editing operation in the first filling box includes at least one of the following manners:
1. Editing operations in at least two first filling boxes are received in sequence on the basis of a territorial scope descending order.

The geographical location configuration option includes at least two first filling boxes, and the at least two first filling boxes respectively correspond to different territorial scopes. In an example, the territorial scope descending order refers to arranging territorial scopes from large to small. For example: the territorial scopes are arranged in a descending order according to countries, provinces, cities, districts and streets. A latter territorial scope is contained in a previous territorial scope, and at least two territorial scopes are separately listed in the at least two first filling boxes. Determining a municipal territorial scope option is taken as an example. The municipal territorial scope option is displayed or presented in a selectable state after a provincial territorial scope selected in the previous first filling box, namely, the territorial scope options are selected in sequence.
2. The editing operation in the first filling box is implemented on the basis of inputting a location keyword.

For example, the first filling box is an inputtable text box, and a country, a province, a city, a landmark and the like having a selection requirement are input to the first filling box, so that the editing operation in the first filling box can be achieved. The input locations may be input according to the territorial scopes in sequence, or may be input in a single text manner, such as inputting scenic spot D. The server may search for geographical location information according to an input content, prompt the inviter to confirm the geographical location information by information, a pop-up window and the like, and achieve the editing operation on the first filling box in response to that the inviter confirms the geographical location information.

In step 320, for a first filling box of the geographical location configuration option, a third trigger operation performed on the first filling box is received.

For example, the first filling box is displayed in the form of a link or a control, and the trigger operation on the first filling box is achieved on the basis of clicking, pressing, touch-control and the like.

In step 321, a map preview interface is displayed in response to the third trigger operation, a positioning operation in the map preview interface is received, and the geographical location acquisition condition is obtained.

In some examples, after the trigger operation is performed on the first filling box, the map preview interface is displayed. The map preview interface can display a preset region nearby by taking a geographical location where the inviter is currently located as a center, or display a preset region nearby on the basis of a geographical location pre-selected by the inviter, or display a whole region map which is dragged by the inviter to a target region. Then, the inviter performs clicking, circling, long-press and other positioning operations on a target position or a target region in the map preview region, to determine that the target location or the target region is the geographical location acquisition condition.

That is, the inviter can configure an acquisition geographical location corresponding to a desired multimedia content, so that the inviter can break through the location limitation to obtain multimedia data corresponding to other geographical locations, which improves the diversity of multimedia interaction.

(2) Qualification Configuration Option

For example, qualifications include feature elements such as the professional competence, awards and year of qualification of the executive party. In the qualification configuration option, one of the above feature elements may be selected or more feature elements may be selected.

With regard to a filling box corresponding to the qualification configuration option, a filling operation performed on the filling box at least includes the following steps:

In step 330, for a second filling box of the qualification configuration option, a fourth trigger operation performed on the second filling box is received.

For example, the second filling box is displayed in the form of a scroll bar. The scroll bar of the second filling box is opened in response to a selection operation.

In step 331, a candidate qualification list is displayed in response to the fourth trigger operation, and a selection operation performed on the candidate qualification list is received, and the qualification condition is obtained.

In some examples, the candidate qualification list is displayed in the scroll bar, including at least one qualification condition. Contents of the qualification condition include feature elements such as professional competence, awards and year of qualification. A qualification acquisition condition is obtained on the basis of a selection of at least one qualification condition in the candidate qualification list. During the selection of qualification conditions, only one qualification condition can be selected as the qualification acquisition condition (for example, an award status that the party had won award B is selected), or a plurality of qualification conditions can also be selected simultaneously as alternatives to obtain the qualification acquisition condition (for example, an award status that the party had won award B or the year of qualification of 5 years is selected), or a plurality of qualification conditions can be simultaneously selected as a comprehensive condition, and the comprehensive condition is used as qualification acquisition condition (for example, an award status that the party had won award B and the year of qualification of 5 years are selected).

That is, the inviter can screen the qualifications of the executive party, so that the obtained multimedia content is more professional, which improves the multimedia content obtaining effect.

(3) Time Configuration Option

With regard to a filling box corresponding to the time configuration option, a filling operation performed on the filling box at least includes the following steps:

In step 340, an editing operation in a third filling box is received for the third filling box of the time configuration option, and a time range condition corresponding to the time configuration option is obtained.

The editing operation is to edit the content of the third filling box. For example, the content of the third filling box is a customized time range, and the inviter can input time information in the form of text in the third filling box. If a text is input: from 10 a.m. to 14 p.m., the time range is used as a time range condition.

In step 350, for a third filling box of the time configuration option, a selection operation performed on the third filling box is received.

For example, the third filling box is displayed as an option. The time range condition is at least displayed in the form of a list, a clock, an electronic watch, or the like.

In step 351, a start time list and an end time list are displayed in response to a selection operation, selection operations performed on the start time list and the end time list are received, and the time range condition is obtained.

For example, the third filling box is displayed as an option. The time range condition is displayed in the form of list, and option contents of the third filling box include start time and end time. The start time list and the end time list are displayed on the basis of a trigger operation performed on the third filling box. The start time list and the end time list can be displayed in a sequential appearance manner, that is, the start time list is firstly triggered and then the end time list is displayed. Or, the start time list and the end time list are displayed in a simultaneous appearance manner. That is, after the selection operation is performed on the third filling box, the start time list and the end time list simultaneously appear. The start time list and the end time list may be arranged at the top and bottom or at the left and right.

In an embodiment, the time configuration option includes a first sub-option and a second sub-option.

The first sub-option and the second sub-option are contained in the time configuration option. The first sub-option and the second sub-option can correspond to a plurality of dimensions of the configuration acquisition condition. Effects of the trigger operations separately performed on the first sub-option and the second sub-option may be different. For example, after the trigger operation is performed on the first sub-option, the first sub-option displays a time list. After the trigger operation is performed on the second sub-option, the second sub-option displays a time text input box.

In step 360, an instant response duration is taken as the time range condition in response to receiving a selection operation performed on the first sub-option.

For example, the time configuration option includes a “Now” option and a “Future” option. The “Now” option corresponds to the first sub-option, and the “Future” option corresponds to the second sub-option. Based on a trigger operation performed on the “Now” option, current time is taken as start time by default, and the instant response duration is taken as the time range condition.

In step 361, the third filling box is displayed in response to receiving a selection operation performed on the second sub-option.

In some examples, based on a trigger operation performed on the “future” option, the third filling box is displayed. The third filling box includes an initial time list and an end time list. The time range condition is obtained on the basis of a selection of the inviter performed on initial time and end time. The initial time list and the end time list appear at the same time or appear in sequence.

(4) Device Configuration Option

For example, devices include a mobile intelligent device, a camera, a video camera, a recording pen and the like. For different devices, there are also differences in terms of brand, function, performance and the like. The device configuration option can summarize and synthesize the above-mentioned feature elements of device type, brand, function, performance and the like.

In some examples, with regard to a filling box corresponding to the device configuration option, a filling operation performed on the filling box at least includes the following steps:

In step 370, an editing operation in a fourth filling box is received for the fourth filling box of the device configuration option, and a device acquisition condition corresponding to the device configuration option is obtained.

The editing operation is to edit a content of the fourth filling box, and content information to which the first filling box can respond is an acquisition condition related to a device condition. For example, an editing form of the fourth filling box exists in a text input form or a voice input form. A click operation is performed on the fourth filling box to trigger a text input function or a voice input function corresponding to the fourth filling box, and then feature elements such as a name, type, brand, function and performance of a device are input, or the above-mentioned feature elements of the device are input by means of voice input, so as to obtain the device acquisition condition corresponding to the device configuration option.

In step 380, for a fourth filling box of the device configuration option, a selection operation performed on the fourth filling box is received.

The selection operation is to select a device condition that has already existed in the fourth filling box, and relevant device conditions are displayed in the form of an option, a drop-down bar, a scroll bar and the like. For example, the fourth filling box displays the device conditions in the form of a drop-down bar.

In step 381, a candidate device list is displayed in response to the selection operation, a selection operation in the candidate device list is received, and the device acquisition condition is obtained.

In some examples, in response to the selection operation, the drop-down bar of the fourth filling box is opened, and the candidate device list is displayed in the drop-down bar, including at least one device condition. Contents of the device condition include the above feature elements. The device acquisition condition is obtained on the basis of a selection of at least one device condition in the candidate device list. During the selection of device conditions, only one device condition can be selected as the device acquisition condition (for example, a mobile phone is selected for photographing); or a plurality of devices conditions can also be selected simultaneously as alternatives to obtain the device acquisition condition (for example, a camera or a mobile phone is selected for photographing); or a plurality of device conditions can be simultaneously selected as a comprehensive condition, and the comprehensive condition is used as device acquisition condition (for example, a camera of the brand ZZ is selected for photographing).

In summary, in the method provided by this embodiment, the first account configures the acquisition conditions in the condition configuration interface, so that a server selects, according to the acquisition conditions, candidate accounts satisfying the acquisition conditions; the first account selects and obtains the second account on the basis of the at least one candidate account, and transmits the interaction message to the second account, thereby realizing a multimedia interaction process of acquiring a multimedia content via the second account. In this way, the first account can break through the limitations of acquisition conditions, such as a recording capability of a device and a geographical location, and more quickly and effectively obtain multimedia contents satisfying the acquisition conditions.

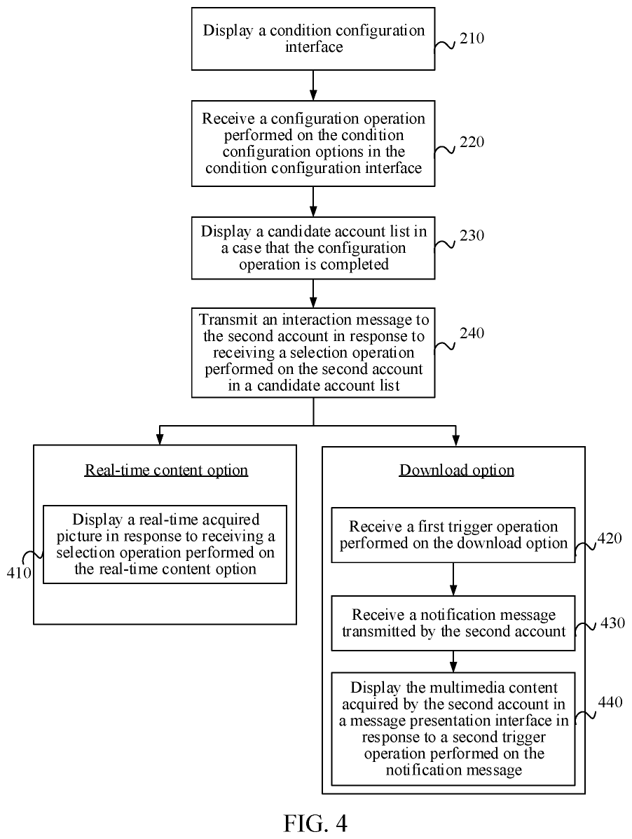

In an embodiment, the invitation accept message includes a real-time content option and a download option. The real-time content option is used for proving the first account with multimedia data acquired by the second data in real time, and the download option is used by the first account to download, within a specified time period, the multimedia data acquired by the second data. For example, as shown in FIG. 4, after step 240 in this embodiment shown in FIG. 2, following Step 410 to Step 440 are further included.

In some examples, after the real-time content option in the invitation accept message is triggered, the flow is as follows.

In step 410, a real-time acquired picture is displayed in response to receiving a selection operation performed on the real-time content option.

The real-time acquired picture is a picture which is acquired in real time by the second account by using a multimedia acquisition device and shared to the first account. For example, the first account is an account logging in to an application program. When the second account accepts the interaction message, the first account displays the invitation accept message. The invitation accept message is displayed in at least several following manners:
1. The invitation accept message appears as a pop-up window. For example, the application program is authorized to display the invitation accept message to a user in the form of a pop-up window. When the first account receives the invitation accept message, an interface of the terminal logged in with the first account is in a desktop interface state, and the invitation accept message is presented in the form of a pop-up window at a center of the desktop interface. The pop-up window includes both a modal pop-up window to which the first account needs to respond and a non-modal pop-up window that the first account can ignore.
2. The invitation accept message appears as a window floating layer. For example, when the first account receives the invitation accept message, the interface of the terminal logged in with the first account is located on the interface of the application program, the invitation accept message is presented on the interface of the application program as a window floating layer, and a display layer of the window floating layer where the invitation accept message is located is located on the interface of the application program and is in a non-full-screen state. In some examples, in order to highlight the invitation accept message during the displaying the window floating layer, displayed contents on the interface of the application program can be weakened. For example: the display brightness of the interface of the application program is reduced; the displayed contents on the interface of the application program are blurred; and the like.
3. The invitation accept message appears as a message bar. For example, the application program is authorized to display the message to a user in the form of a message bar. When the first account receives the invitation accept message, an interface of the terminal logged in with the first account is an interface of another application program, and the invitation accept message is presented in a message bar in a message prompt manner.

The invitation accept message includes the real-time content option. The first account can obtain a data acquisition process of the second account by triggering the real-time content option, that is, the first account can watch, listen and view the process that the second account acquires the multimedia content. In some examples, the acquisition condition of the first account is that the second account uses a mobile phone to photograph a garden. After the first account performs a selection operation on the real-time content option, the first account can obtain the process that the second account uses the mobile phone to photograph the garden, that is, the first account can view in real time pictures taken by the second account using the mobile phone.

That is, in this embodiment of this disclosure, the inviter is provided with displaying of a real-time acquired picture, so that the inviter can more conveniently instruct the executive party to acquire the desired multimedia content. At the same time, since the inviter can determine the multimedia content currently acquired by the executive party through the real-time acquired picture, back-and-forth transmission of an acquisition requirement is reduced, and the frequency of data interaction between the terminal and the server is lowered.

In an embodiment, a terminal control operation is received during the displaying the real-time acquired picture; and a control message is transmitted to the second account on the basis of the terminal control operation, the control message being used for instructing the second account to perform an operation synchronized with the terminal control operation.

For example, when a first account views the picture taken by the second account in real time, the first account can instruct the second account to move a photographing device by means of moving a watching device (for example, a mobile phone). For example, the first account hopes the second account to photograph a lake in the garden at the center position of the picture. However, the lake photographed by the second account is on the left side of the picture. The first account can choose to inform, by voice, the second account to move the photographing device to the left side, or can choose to directly move its own watching device to the left. The terminal logged in with the first account receives the movement control operation to instruct transmitting a movement control message to the second account. The mobile device logged in with the second account may display, on a screen of the device, the control message indicating that the first account moves to the left. The second account can move the photographing device to the left according to the prompt, to meet the photographing requirement of the first account.

That is, the inviter can control the terminal of the executive party in real time through the terminal control operation, which improves the convenience of acquiring the desired multimedia content by the inviter and improves the multimedia interaction efficiency, so that the inviter has a greater sense of operation substitution during the obtaining of the multimedia content.

In an embodiment, after the download option in the invitation accept message is triggered, when the first account receives the invitation accept message, the invitation accept message includes the download option. By clicking the download option, the first account does not display, by default, the real-time multimedia content acquired by the second account, but downloads a generated file after the second account completes the acquisition of the multimedia content. Or, by clicking the download option, the first account temporarily does not display the picture acquired by the second account in real time, and the second account can view the real-time picture again through the real-time content option of the application program. The server gathers the pictures acquired by the second account, so that the first account can download the pictures. After the download option is triggered, the flow of this embodiment is as follows:

That is, the inviter can download the multimedia content in real time through the provided download option, which improves the efficiency of the inviter for obtaining a multimedia content.

In step 420, a first trigger operation performed on the download option is received.

In an example, the download option exists as a control in the invitation accept message. After the invitation accept message is displayed, when the first trigger operation performed on a download control in the invitation accept message is received, a function corresponding to the download control is triggered, such as: a download function (downloading the multimedia content acquired by the second account), a prompt function (prompting, by means of vibration feedback, that the download control is triggered), a notification message transmitting function (notifying the second account of the message for downloading the multimedia content), and the like.

In an example, the download option is used for providing the first account with an option to download the multimedia data acquired by the second account within a specified time period. In some examples, the above specified time period may be any time period after current time.

In step 430, a notification message transmitted by the second account is received.

The notification message is information of exchange between the first account and the second account. For example, the application program logged in by the first account and the application program logged in by the second account are the same application program logged in by different terminals, and the application program has a social function (for example: the interaction message is transmitted through a dialog box). After the second account completes the acquisition of the multimedia content, a dialog can be initiated in a dialog box with the first account via the application program, to notify that the acquisition is completed or to notify other information about the acquisition of the multimedia content. Or, after the second account completes the acquisition of the multimedia content, the terminal logged in with the second account automatically transmits a notification message to the first account on the basis of the completion of the acquisition, to realize that the second account transmits the notification message to the first account.

In step 440, the multimedia content acquired by the second account is displayed in a message presentation interface in response to a second trigger operation performed on the notification message.

For example, after the second account completes the acquisition of the multimedia content, the terminal logged in with the second account automatically transmits the notification message to the first account. The notification message contains the multimedia content acquired by the second account (for example: the notification message is video picture information acquired by the second account). Or, the terminal jumps to the message presentation interface by viewing the notification message (for example: the notification message is “The acquisition has been completed. Click this link to view the photographed content”). In some examples, the message presentation interface can be an interface of an application program for content acquisition, or can be an interface of an application program with a cloud storage function, or can be a mini program interface in an application program with a social function.

In an embodiment, a commenting operation performed on the multimedia content in a comment region is received.

For example, the message presentation interface further includes the commenting region. By using the message presentation interface, the first account can view the acquired multimedia content, and also download and edit the multimedia content, or make a comment on the completion of the acquisition of the multimedia content by the second account. The first account can select a true name or a nickname to make a comment, or can make a comment disguisedly.

In some examples, after the second account completes the acquisition of the multimedia content, the first account may make a comment on the acquisition process, result and the like of the second account in the comment region. For example, the acquired multimedia content is video capturing of scenic spot XX. After the second account completes the video capturing task, the first account can perform, in the message presentation interface, commenting and analysis on the content, light, skill and the like of a video captured by the second account. A comment content can be known to other accounts in an open form, or can be only known to friends in the form of being visible to only friends.

That is, the inviter can comment an acquisition result of the multimedia content for the executive party, so that other inviters can refer to the corresponding comment content when selecting executive parties, to provide a reference for an inviter account during the selection of executive party accounts, which improves the selection efficiency and selection effectiveness of the inviter account for selecting executive party accounts, and reduce the possibility of reselecting an account and re-obtaining a multimedia content.

In some embodiments, the download option may also be displayed after the real-time option appears.

For example, when the first account receives the invitation accept message, the invitation accept message contains the real-time content option, and the first account views a real-time picture acquired by the second account after choosing to trigger the real-time content option. At the same time, the download option is displayed on one side of the real-time picture (for example: the right side, the lower left corner, and the like of the real-time picture), and the first account triggers the download option to download the current acquired picture, and downloads subsequent acquired picture by default. Or, when the download option is triggered, downloading may be performed after the second account completes the acquisition of the acquired picture is completed. Or, after the download option is triggered, the first account exits the real-time picture temporarily by default, and then downloads the acquired picture after the second account completes the acquisition.

In some examples, both the real-time content option and the download option can share the acquired multimedia content to a cloud in real time. In the process of acquiring the multimedia content by the second account or after the second account completes the acquisition of the multimedia content, the acquired picture can be viewed and downloaded by the first account. The first account can re-view and re-download, by means of setting an allow-to-view state, the acquired content after the second account completes the acquisition of the multimedia content. The above is merely an illustrative example, and this embodiment of this disclosure does not limit this.

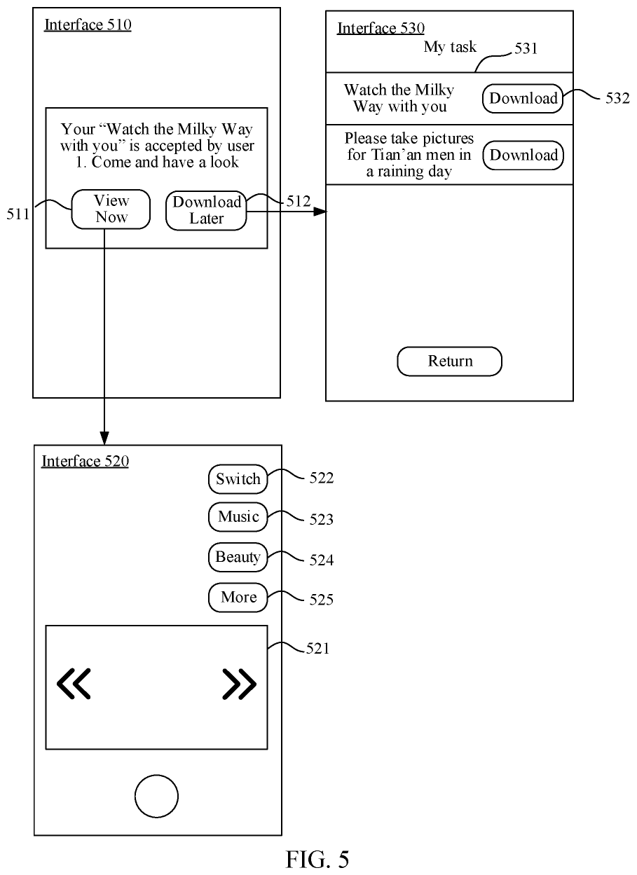

FIG. 5 shows an exemplary schematic diagram of an interface of the terminal logged in with the first account, when the invitation accept message received by the first account includes a real-time content option and a download option.

An interface 510 shows the invitation accept message received by the first account after the second account receives the interaction message and satisfies the acquisition condition. In the interface 510, user 1 is the “second account”; “Take pictures of the Milky Way with you” is the title of the interaction message transmitted by the first account; and a main content of the interaction message is that the first account invites the second account to take pictures. As shown in the interface 510, the invitation accept message includes a View Now option 511 and a Download Later option 512.

If the first account triggers the View Now option 511, an interface 520 is displayed on the terminal logged in with the first account. The interface 520 includes a real-time picture 521 acquired by the second account, and also includes a function control, a special effect control, and other controls, such as a switch control 522, a music control 523, a beauty control 524 and a control 525 capable of expanding more functions, which are used for editing the acquired real-time picture in the photographing process. For example, the first account and the second account enter the same real-time picture on the basis of a trigger operation performed on the View Now option 511. When the first account moves the watching device (for example: a mobile phone) of the first account to the left, right, top or bottom, a corresponding arrow prompt will be displayed on a screen of a terminal logged in with the second account, to prompt the second account to follow a specified action of the first account for photographing. In addition, the first account may choose to perform a trigger operation on functional controls such as the music control 523 and the beauty control 524, and the server may synchronize functional options corresponding to these functional controls to the mobile phone of the photographer and apply same to a generated multimedia file.

If the first account triggers the Download Later option 512, an interface 530 is displayed on the terminal logged in with the first account. The interface 530 includes task titles 531 that have been acquired by the second account, and also includes a download control 532 corresponding to each acquired task title 531. For example, an acquisition task is performed autonomously by the second account on the basis of a trigger operation performed by the first account on the Download Later option 512. The acquired multimedia content is uploaded to the server on the basis of the completion of the acquisition task of the second account. The first account may enter, at any time, a task list in an application program that posts tasks, or task lists in other relevant application programs. Different acquisition tasks are distinguished according to a difference of the task titles 531. The download controls 532 corresponding to the task titles 531 after the acquisition is completed are triggered to selectively download corresponding videos.

In summary, in the method provided by this embodiment, the first account configures the acquisition conditions in the condition configuration interface, so that a server selects, according to the acquisition conditions, candidate accounts satisfying the acquisition conditions; the first account selects and obtains the second account on the basis of the at least one candidate account, and transmits the interaction message to the second account, thereby realizing a multimedia interaction process of acquiring a multimedia content via the second account. In this way, the first account can break through the limitations of acquisition conditions, such as a recording capability of a device and a geographical location, and more quickly and effectively obtain multimedia contents satisfying the acquisition conditions.

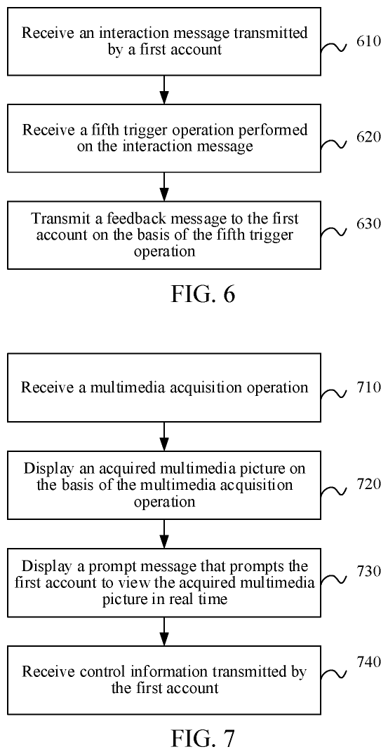

FIG. 6 is a flow diagram of a multimedia interaction method provided according to another exemplary embodiment of this disclosure. An example in which method is applied to an invitation terminal is taken for description. As shown in FIG. 6, the method includes the following steps:

In step 610, an interaction message transmitted by a first account is received.

The interaction message is a message indicating that the first account invites a second account to acquire a multimedia content, and is used for instructing the second account to perform multimedia acquisition interaction with the first account. The currently logged in second account is an account satisfying acquisition conditions.

For example, the interaction message includes acquisition conditions configured by the first account for acquisition of the multimedia content.

In step 620, a fifth trigger operation performed on the interaction message is received.

The fifth trigger operation is an operation performed by the second account on the interaction message. In some examples, the fifth trigger operation is achieved in at least several following ways.
1. A trigger operation performed on the interaction message is regarded as the fifth trigger operation.

For example, the interaction message is in the form of a floating window. The fifth trigger operation performed on the interaction message is completed in response to a trigger operation performed on the floating window.
2. A selection operation performed on the interaction message is regarded as the fifth trigger operation.

In an example, the interaction message is in the form of an interface. The interaction message interface includes at least two options corresponding to different functions. The fifth trigger operation performed on the interaction message is completed in response to a selection operation performed on at least one of the at least two options in the interaction message.

In step 630, a feedback message is transmitted to the first account based on the fifth trigger operation.

The feedback message is used for indicating an interaction response of the second account to the acquisition of the multimedia content.

In an embodiment, an invitation accept message is transmitted to the first account in response to receiving an accept operation performed by the second account on the interaction message.

The accept operation is used for instructing the second account to accept the interaction message, and the invitation accept message is used for indicating that the second account accepts the invitation to acquire a multimedia content. For example, after the first account transmits the interaction message to the second account via the server, the second account chooses to accept the interaction message, namely, the second account decides to assist in the interaction message transmitted by the first account. A terminal logged in with the second account transmits the invitation accept message to the first account on the basis of the acceptance of the second account for the acquisition of the multimedia content, to prompt the first account of the acceptance of the second account for the interaction message.

In an embodiment, an invitation reject message is transmitted to the first account in response to receiving a reject operation performed by the second account on the interaction message.

The reject operation is used for instructing the second account to reject the interaction message. For example, after the first account transmits the interaction message to the second account via the server, the second account chooses to reject the interaction message, namely, the second account does not assist in the interaction message transmitted by the first account. The terminal logged in with the second account transmits the invitation reject message to the first account on the basis of the rejection of the second account for the acquisition of the multimedia content, to prompt the first account of the rejection of the second account for the interaction message.

In summary, in the method provided by this embodiment, the first account configures the acquisition conditions in the condition configuration interface, so that a server selects, according to the acquisition conditions, candidate accounts satisfying the acquisition conditions; the first account selects and obtains the second account on the basis of the at least one candidate account, and transmits the interaction message to the second account, thereby realizing a multimedia interaction process of acquiring a multimedia content via the second account. In this way, the first account can break through the limitations of acquisition conditions, such as a recording capability of a device and a geographical location, and more quickly and effectively obtain multimedia contents satisfying the acquisition conditions.

In an embodiment, as shown in FIG. 7, after step 630 in this embodiment shown in FIG. 6, following Step 710 to Step 740 are further included.

In step 710, a multimedia acquisition operation is received.

The multimedia acquisition operation refers to an acquisition operation performed on the multimedia content. In some examples, the multimedia content has various forms, and the acquisition operation of the multimedia contents includes at least the following manners.
1. The multimedia acquisition operation is recording.

For example, when a multimedia content to be acquired is an audio multimedia, an audio content can be acquired using a better recording manner on the basis of considering data compression and data storage, that is, only sound is acquired.
2. The multimedia acquisition operation is photographing.

For example, when a multimedia content to be acquired is a video multimedia, a video content can be acquired using a better photographing manner on the basis of a need for acquiring picture information, sound information and the like in a video, that is, pictures, sounds and the like in the video are acquired.

In step 720, an acquired multimedia picture is displayed based on the multimedia acquisition operation.

The acquired multimedia picture is a real-time displayed picture when the second account performs multimedia acquisition.

For example, when the acquired multimedia content is the video multimedia, the multimedia acquisition operation may be photographing, and the multimedia acquisition operation is achieved on the basis of photographing a video. In the process of photographing a video, the terminal logged in with the second account can display a photographing picture of the video, namely, the acquired multimedia picture.

In step 730, a prompt message is displayed. The prompt message prompts that the acquired multimedia picture is viewed by the first account in real time.

For example, when the second account acquires the multimedia content, the first account may view acquired pictures of the second account. In some examples, when the first account views the acquired picture in real time, the acquired picture of the second account may receive a prompt message that the first account views the acquired multimedia picture in real time. The prompt message is displayed in at least several following ways.
1. The prompt message is displayed as a pop-up window (floating window).

For example, when the first account views a real-time acquired picture, a message pop-up window (floating window) appears in the acquired picture of the second account, and the message pop-up window (floating window) is used for prompting the second account that the current acquired picture is viewed by the first account. The pop-up window (floating window) can either disappear after the second account clicks a cancel control, or disappear after a display duration reaches a preset duration, to avoid the interference of the prompt message on the acquired picture. In some examples, a vibration feedback may be generated, during the displaying of the prompt message, at the terminal logged in with the second account, or a specific vibration feedback may be used as the prompt message.
2. The prompt message is displayed as a list.

For example, when the second account acquires a multimedia content, an account view list for indicating an account that views the current acquired picture is displayed on one side of the acquired picture. When the first account views a real-time acquired picture, the first account is added to the account view list. In some examples, the second account is prompted, with the nickname, chathead and other information of the first account, that the first account views the acquired multimedia picture in real time. In some examples, the acquired picture can be set to be in a conditional view mode, that is, acquired multimedia content can be viewed because other accounts satisfy specific additional conditions, and the account view list can correspondingly display information of other accounts.

In step 740, control information transmitted by the first account is received.

The control message is a message transmitted by the first account through a control operation performed on a terminal, and the control message is used for instructing the second account to perform a control operation synchronized with that of the first account.

For example, when the first account views pictures taken by the second account in real time, the first account can instruct, by moving a watching device, the second account to move a photographing device. In some examples, the terminal logged in with the first account has an action recognition function. When the first account moves the watching device, the terminal (for example: a mobile device terminal) logged in with the first account may transmit a control message to the second account on the basis of the movement of the first account. The control message contains movement information of the first account, and may instruct the second account to perform a control operation synchronized with that of the first account. The control message may be indicated by an arrow (for example: an arrow to the left is displayed on the acquired picture, and disappears until the photographing device moves to a position synchronized with that of the first account), and may also be indicated by vibration (for example: vibration is generated on the right side of the terminal logged in with the second account, and stops until the photographing device moves to a position synchronized with that of the first account). In some embodiments, the control message can also be implemented as a photograph control message, that is, the first account selects a desired photographing angle and clicks a photograph control when watching a photographed picture video stream, to transmit the photograph control message to a second account. The second account selects, from the photographed picture video stream according to the received photograph control message, a picture frame, displayed when the photograph control message is received, as a picture frame image acquired for application.

In summary, in the method provided by this embodiment, the first account configures the acquisition conditions in the condition configuration interface, so that a server selects, according to the acquisition conditions, candidate accounts satisfying the acquisition conditions; the first account selects and obtains the second account on the basis of the at least one candidate account, and transmits the interaction message to the second account, thereby realizing a multimedia interaction process of acquiring a multimedia content via the second account. In this way, the first account can break through the limitations of acquisition conditions, such as a recording capability of a device and a geographical location, and more quickly and effectively obtain multimedia contents satisfying the acquisition conditions.

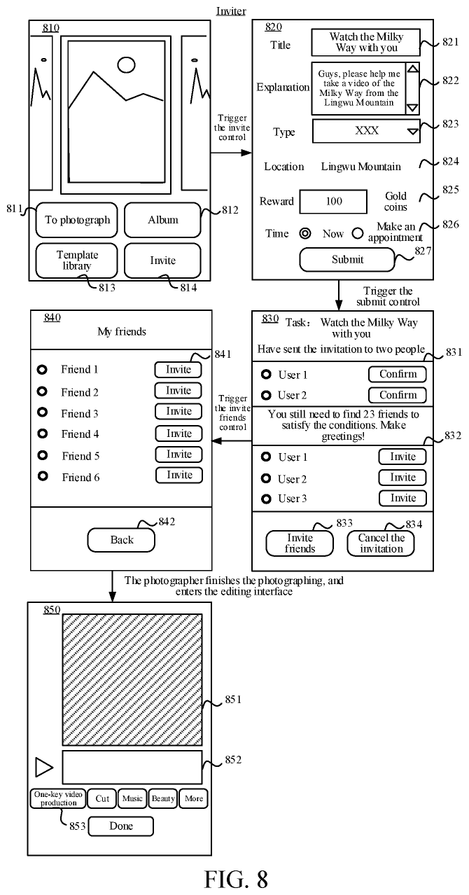

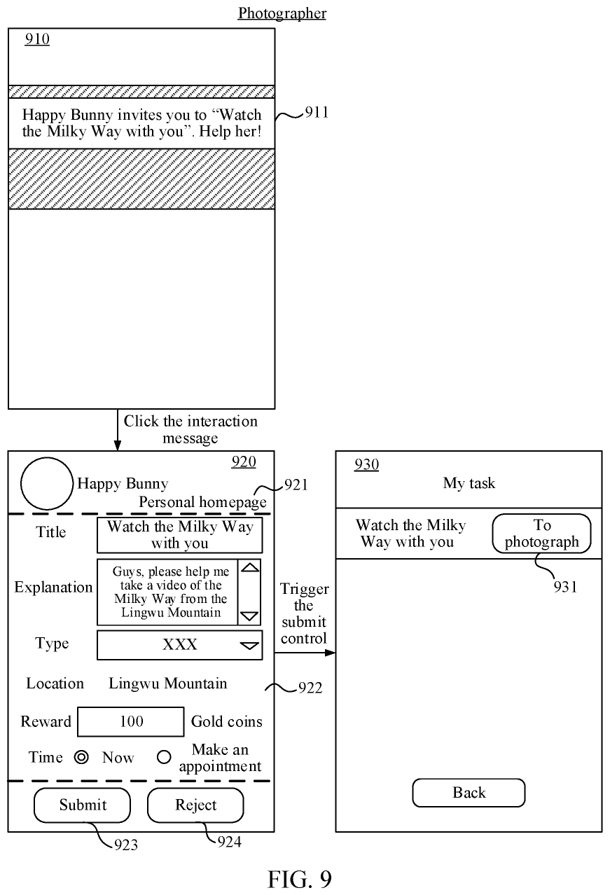

FIG. 8 and FIG. 9 show schematic diagrams of interface interaction provided by an exemplary embodiment. FIG. 8 shows a schematic diagram of an interface of an inviter, and FIG. 9 shows a schematic diagram of an interface of a photographer.

I: As shown in FIG. 8, the process of the inviter is as follows:

In some examples, a process of obtaining a multimedia content is performed in an application program. The application program includes functions such as video recording and video sharing. For example, a production interface 810 is a process interface of the application program for producing a video or posting a video, and the production interface 810 includes a photograph control 811, to perform photographing using a current device at current time. The production interface further includes an album control 812 used for selecting a video or picture from an album of the current device to perform production or posting. The production interface further includes a template library control 813 used for selecting a template from the current application program or other template libraries to perform production or posting. The production interface further includes an invitation control 814 used for implementing a process of inviting other users to assist in obtaining a multimedia content.

In an example, a condition configuration interface 820 is displayed after a trigger operation is performed on the invitation control 814. Condition configuration interface 820 includes:
1. A condition keyword “title” and a corresponding title filling box 821, to summarize a posted acquisition task.
2. A condition keyword “explanation” and a corresponding explanation filling box 822, to further introduce the posted acquisition task on the basis of the summary of the “title”, and to remark precautions to which an executive party needs to pay attention during the completion of the acquisition task.
3. A condition keyword “type” and a corresponding type filling box 823, to take “type” as an acquisition condition on the device of the executive party.
4. A condition keyword “location” and a corresponding location filling box 824, to limit a geographical location where the executive party is located during video photographing, where the location filling box 824 may be presented in a manner of map positioning, namely, the location filling box 824 is triggered to present a map interface, and contents of the location filling box 824 is determined according to a geographical location or a territorial scope selected on a map.
5. A condition keyword “award” and a corresponding reward filling box 825, to label benefits that can be obtained after the acquisition task is completed, where rewards can also be divided in grades according to a completion status of the task of the executive party, and quantifiers corresponding to the reward filling box 825 can also be replaced.
6. A condition keyword “time” and a corresponding time filling box 826, to take “time” as an acquisition condition on a device of an executive party.
7. A submit control 827 used for, when condition configuration is completed and determined, submitting the acquisition conditions to the server, so that the server selects, according to the acquisition conditions, an executive party satisfying the acquisition conditions.

Configured conditions provided by the above condition configuration options can be added or deleted according to different acquisition conditions, or some configuration conditions can be selectively not filled out. The above interfaces are merely illustrative examples, and this embodiment of this disclosure does not limit this.

In some examples, after a trigger operation is performed on submit control 827, an invitation task is posted successfully, and the server selects, according to acquisition conditions (type, location, time and the like), an executive party satisfying the acquisition conditions, and obtains an account list satisfying the conditions, as shown in a list interface 830. On the one hand, the server automatically posts invitation information to user 831 satisfying the conditions and waits for confirmation; and on the other hand, the inviter may actively invite, on the list interface 830, more users 832 to assist in photographing. In addition, the list interface 830 also includes an invite friends control 833 and an invitation cancel control 834. The invitation cancel control 834 is used for ending the current invitation task, and the invite friends control 833 is used for transmitting the invitation information to friends. The friends include both accounts having a friend relationship with the inviter and accounts having a temporary dialogue with the inviter. For example, a friends interface 840 is displayed on the basis of triggering on the invite friends control 833. Friend 1, friend 2, and the like all satisfy the above-mentioned friend concept, and each friend corresponds to an invite control 841 used for transmitting an invitation request to the corresponding friend. A back control 842 used for exiting the friends interface is also included.

II: As shown in FIG. 9, after the inviter transmits an invitation request to the photographer, the process of the photographer is as follows:

After the photographer receives the invitation request, a prompt interface 910 will be displayed on the terminal of the photographer. The prompt interface 910 includes an invitation request 911 indicating: Happy Bunny invites you to “Watch the Milky Way with you”. Help her! The photographer can ignore the invitation request by means of left sliding, clearing the current application program, and the like. That is, these actions are considered as rejecting the invitation request or ignoring the invitation request. Or, the photographer can choose to click the invitation request and view task details.

In some examples, the photographer clicks the invitation request to enter a task details interface 920. The task details interface 920 includes chathead information and nickname information of the inviter that posts the task, and the photographer can also click a personal homepage prompt 921 to enter a personal homepage of the inviter and view more personal information of the inviter. In addition, the task details interface 920 also includes acquisition conditions 922 (shown in the dashed box) posted by the inviter. The photographer can choose to trigger a submit control 923 on the basis of determinations on the acquisition conditions and the inviter, to accept the acquisition task, or can trigger a reject control 924, to reject the acquisition task.

When the photographer triggers the submit control 923 to accept the acquisition task, a task interface 930 is displayed. The task interface 930 includes the task accepted by the photographer, for example, “Watch the Milky Way with you”. When the photographer triggers a photograph control 931, the server determines again whether the photographer satisfies the acquisition conditions. When the photographer satisfies the acquisition conditions, the photograph control 931 is in a clickable state (for example: the color turns from gray to be colored, the photograph control presents an entity state, and the like). After triggering the photograph control 931, the photographer can invoke a camera function of the device to take pictures.

III: As shown in FIG. 8, after the photographer finishes photographing a video, the inviter can perform operations such as downloading and editing on the video, and the interface 850 displays an interface where the inviter edits the video:

After the photographer finishes photographing the video according to the request of the inviter, the video is stored in a cloud, so that the inviter can download the video while watching the video in real time, that is, the inviter downloads the video while watching the video; and the inviter can also select Download Later, that is, the video is downloaded after the photographer finishes recording the video. When the inviter obtains the downloaded video, the inviter can edit the video. In some examples, the video can be edited in the application program for invitation, as shown in the editing interface 850. In the interface 850, video frames of the video corresponding to current time can be watched through video preview 851, and video frames of the video corresponding to time before and after the current time can be watched through video progress 852 below. In addition, the inviter can cut the downloaded video, add music and filters to the video, and use beauty effects on the video, or can trigger a one-key video production control 853 to quickly edit the video. Through the above operations, further operations can be performed on the video photographed by the photographer, so that the edited video is more in line with the requirements of the inviter, and the photographer can post the edited video, to achieve multimedia interaction.

In summary, in the method provided by this embodiment, the first account configures the acquisition conditions in the condition configuration interface, so that a server selects, according to the acquisition conditions, candidate accounts satisfying the acquisition conditions; the first account selects and obtains the second account on the basis of the at least one candidate account, and transmits the interaction message to the second account, thereby realizing a multimedia interaction process of acquiring a multimedia content via the second account. In this way, the first account can break through the limitations of acquisition conditions, such as a recording capability of a device and a geographical location, and more quickly and effectively obtain multimedia contents satisfying the acquisition conditions.

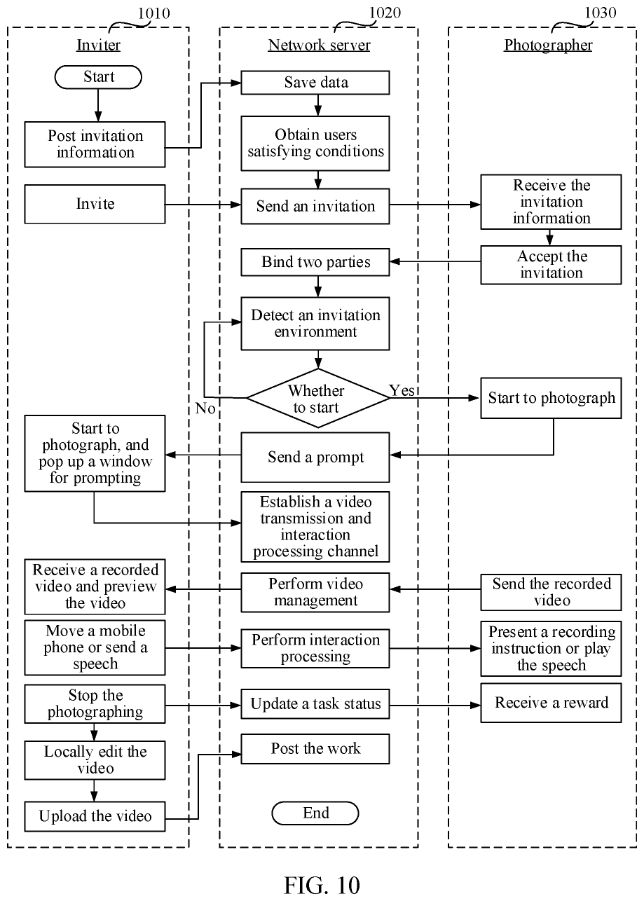

FIG. 10 shows an overall flow diagram provided according to another exemplary embodiment.

This embodiment provides a method procedure, which involves information exchange of three parties in total, including an inviter 1010, a network server 1020, and a photographer 1030.

An exemplary implementation of the method according to this embodiment is as follows:

Firstly, the inviter 1010 creates invitation information. The invitation information is used for describing specific requirements of the invitation, and may contain a title, an explanation, a type, a location, rewards and other information, and then the inviter 1010 submits the invitation information to the network server 1020.

After receiving the request, the network server 1020 stores invitation information of users. The invitation information includes the specific conditions of the inviter 1010. Feature information of all the users is queried according to the specific conditions of the inviter 1010 (for example: the type, the time, and the location), and matching is performed on all user lists satisfying the conditions through an algorithm.

After a user list is matched, the network server 1020 will automatically transmit an invitation to users satisfying the conditions. At the same time, in order to avoid a task from being accepted by multiple people, the users will be invited in batches. In addition, the inviter 1010 may also actively invite more matching users, or invite own friends to complete the task.

After the network server 1020 transmits the invitation information, the photographer 1030 will receive the invitation information, and the invitation information is displayed as a task bar, a pop-up window, or the like. The photographer 1030 performs a trigger operation on the message bar to jump to an invitation details interface.

On the invitation details page, the complete invitation information as previously stated can be read. The photographer 1030 can select accept or reject. If the user selects reject, the user will no longer receive the invitation information of this task, and at the same time, the network server 1020 may automatically transmit the invitation information to other users. If a user chooses to accept the invitation, the network server binds the task to the user of the photographer 1030.

After the task is bound to the photographer 1030, the network server 1020 may detect in real time whether the current photographer 1030 satisfies photographing conditions, and the photographing conditions are mandatory in the invitation information, such as location and time. When the photographer 1030 satisfies the photographing conditions, a photograph button in the task list of the photographer 1030 is highlighted and clickable.

After the photographer 1030 clicks the photograph button, the network server 1020 may update a task status and reminds the inviter 1010 of a pop-up window with information about start photographing. If the inviter 1010 selects Watch Now, video information recorded by the photographer can be watched in real time. In addition, the inviter 1010 can also change the orientation of the mobile phone, recognize a movement direction of the user via a sensor, such as a gyroscope, loaded on the terminal of the inviter 1010, generate a direction instruction, and transmit same to the terminal of the photographer 1030. After receiving the direction instruction, the terminal of the photographer 1030 displays an arrow of a corresponding direction on the recording interface to prompt the camera 1030 to move the mobile phone. In addition, in order to ensure a recording effect, the inviter 1010 may transmit a voice indication to the photographer. Finally, after the photographer 1030 or the inviter 1010 triggers a recording end button, the recording of the current invitation task ends, and the recorded video information is automatically transmitted to the terminal of the inviter 1010 and the network server 1020.

After the photographing stops, the network server 1020 releases an award of a specified amount to the photographer 1030 according to a task completion status, and the invitation task is completed.

If the inviter 1010 selects Download Later, the current operation of the inviter 1010 is not affected, and the whole photographing operation is completed by the photographer 1030 alone and uploaded to the network server 1020. Then, the inviter 1010 can see a download entry in a task list page, and can download the video information recorded by the photographer 1030 after clicking Download.

After receiving or downloading the recorded video, the inviter 1010 enters a video editing interface. In this interface, the user can select music, filters and other special effects for creation locally. After the creation is completed, a final short video is generated. The user clicks Upload to post this work to the network server 1020.

In summary, in the method provided by this embodiment, the first account configures the acquisition conditions in the condition configuration interface, so that a server selects, according to the acquisition conditions, candidate accounts satisfying the acquisition conditions; the first account selects and obtains the second account on the basis of the at least one candidate account, and displays a feedback message, thereby realizing a multimedia interaction process of acquiring a multimedia content via the second account. In this way, the first account can break through the limitations of acquisition conditions, such as a recording capability of a device and a geographical location, and more quickly and effectively obtain multimedia contents satisfying the acquisition conditions.

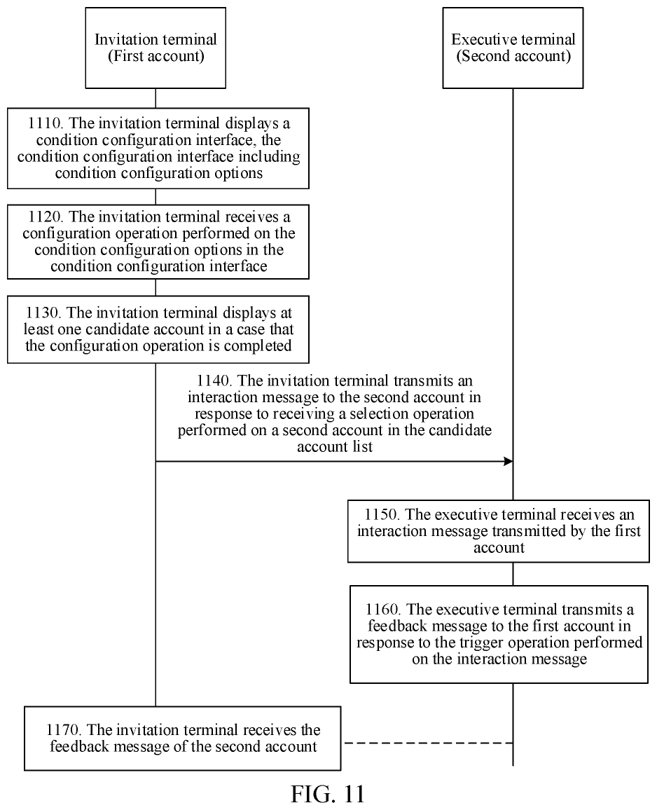

In an embodiment, with regard to a multimedia interaction system including an invitation terminal and an executive terminal, an interaction process between the two terminals is taken as an example to describe the multimedia interaction method provided in the embodiments of this disclosure. The invitation terminal is logged in with a first account, and the executive terminal is logged in with a second account. FIG. 11 is a flow diagram of a multimedia interaction method provided according to another exemplary embodiment of this disclosure. As shown in FIG. 11, the method includes:

In step 1110, the invitation terminal displays a condition configuration interface, the condition configuration interface includes condition configuration options.

The condition configuration options are used for configuring acquisition conditions for acquiring a multimedia content, namely, acquisition conditions are determined through the condition configuration options. The condition configuration options include at least a title configuration option, a resource exchange condition configuration option, a remark configuration option, a device configuration option, a geographical location configuration option, a time configuration option, and a qualification configuration option. Different acquisition conditions, namely, scopes of the acquisition conditions, can be distinguished according to the different condition configuration options.

In an embodiment, the condition configuration interface includes at least two condition configuration options. The at least two configuration options are displayed in the condition configuration interface in at least the following ways:
1. The at least two condition configuration options are displayed in a tiled and parallel manner in the condition configuration interface.
2. The at least two condition configuration options are switched correspondingly for at least two tabs in the condition configuration interface.

In step 1120, the invitation terminal receives a configuration operation performed on the condition configuration options in the condition configuration interface.

The condition configuration options are used for configuring acquisition conditions for acquiring a multimedia content. For example, the condition configuration options include condition keywords and filling boxes. For a filling box corresponding to the condition keyword, a filling operation, as the configuration operation, performed on the filling box is received. Different condition keywords represent different acquisition conditions, and correspond to different filling boxes. In some examples, one condition keyword corresponds to at least one filling box, and the filling box is used for configuring at least one acquisition condition. Filling boxes may exist as options or input boxes, or may exit in an expanded displaying manner.

In step 1130, the invitation terminal displays at least one candidate account when the configuration operation is completed.

The at least one candidate account is an account matching a configured acquisition condition. In some embodiments, the above at least one candidate account is displayed in a candidate account list. The acquisition condition is a limiting condition for the candidate accounts. When the configuration operation is completed, the configured acquisition condition is determined thereby. When an account satisfies the configured acquisition condition, the account is used as a candidate account.

In step 1140, the invitation terminal transmits an interaction message to the second account in response to receiving a selection operation performed on a second account in the candidate account list.

The interaction message is a message generated by selecting a second account by the first account. The first account is an account logging in to the condition configuration interface, and the second account is an account which satisfies the acquisition condition and is selected by an inviter. The invitation terminal receives the interaction message generated after the first account performs the selection operation on the second account, and transmits the interaction message to the executive terminal.

In step 1150, the executive terminal receives an interaction message transmitted by the first account.

In some examples, the executive terminal receives the interaction message transmitted by the first account, and performs a trigger operation on the interaction message.

In step 1160, the executive terminal transmits a feedback message to the first account in response to the trigger operation performed on the interaction message.

In some examples, the executive terminal transmits the feedback message to the first account on the basis of the trigger operation performed on the interaction message. The feedback message includes at least one of an invitation accept message and an invitation reject message.

In some embodiments, the executive terminal displays a photograph interface while transmitting the feedback message to the first account. In an example, when the feedback message is the invitation accept message, the photograph interface on the executive terminal displays a triggerable photograph control.

In step 1170, the invitation terminal receives the feedback message of the second account.

The feedback message includes an interaction response that the first account invites the second account to acquire a multimedia content, that is, result feedback of the acquisition of the multimedia content based on the acquisition conditions, and an operation of the second account on the interaction message can be known according to the feedback message of the second account transmitted by the executive terminal. For example, if the second account confirms the interaction message, the invitation terminal receives and displays the invitation accept message of the second account. If the second account rejects the interaction message, the invitation terminal receives and displays the invitation reject message of the second account. In some examples, if the second account does not perform a confirm or reject operation on the interaction message within a preset duration, the invitation terminal receives and displays an invitation failure message.

In conclusion, the system provided by this embodiment includes the invitation terminal and the executive terminal. The condition configuration interface of the invitation terminal is logged in with the first account. The first account configures the acquisition conditions in the condition configuration interface, so that a server selects, according to the acquisition conditions, candidate accounts satisfying the acquisition conditions; the first account selects and obtains the second account on the basis of the at least one candidate account, and transmits the interaction message to the executive terminal; and the invitation terminal displays the feedback message on the basis of the operation performed by the second account on the interaction message, to achieve the multimedia interaction process. By the above system, the first account logging in to the invitation terminal can break through the limitations of acquisition conditions, such as a recording capability of a device and a geographical location, and more quickly and effectively obtain, with the help of the second account logging in to the executive terminal, multimedia contents satisfying the acquisition conditions.

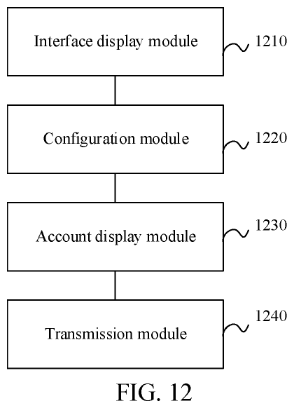

FIG. 12 is a structural block diagram of a multimedia interaction apparatus provided according to one exemplary embodiment of this disclosure. As shown in FIG. 12, the apparatus includes an interface display module 1210, a configuration module 1220, an account display module 1230, and a transmission module 1240.

The interface display module 1210 is configured to display a condition configuration interface, the condition configuration interface includes condition configuration options, and the condition configuration interface is logged in with a first account;

The configuration module 1220 is configured to receive a configuration operation performed on the condition configuration options in the condition configuration interface, the condition configuration options are used for configuring acquisition conditions for acquiring a multimedia content.

The account display module 1230 is configured to display at least one candidate account when the configuration operation is completed, the at least one candidate account includes an account matching a configured acquisition condition.

The transmission module 1240 is configured to transmit an interaction message to the second account in response to receiving a selection operation performed on a second account among the at least one candidate account, the interaction message is a message indicating that the first account invites the second account to acquire the multimedia content, and the interaction message is used for instructing the second account to perform multimedia acquisition interaction with the first account.

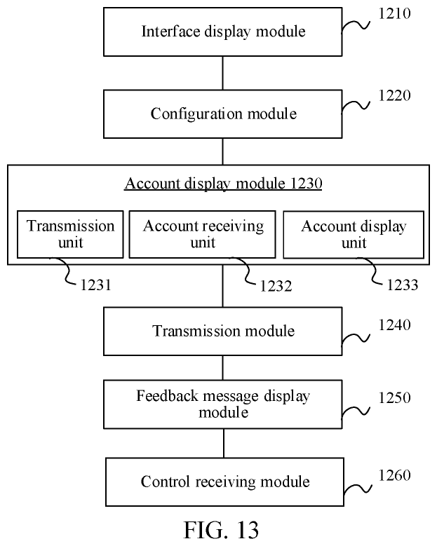

As shown in FIG. 13, in an embodiment, the apparatus further includes feedback message display module 1250 configured to display a feedback message of the second account, the feedback message is a message fed back by the second account for the interaction message.

In an embodiment, the feedback message includes an invitation accept message or an invitation reject message. The feedback message display module 1250 is configured to display the invitation accept message, the invitation accept message being used for indicating that the second account accepts the invitation to acquire the multimedia content; or, display the invitation reject message, the invitation reject message being used for indicating that the second account rejects the invitation to acquire the multimedia content.

In an embodiment, the invitation accept message includes a real-time content option, and the real-time content option is used for providing the first account with multimedia data acquired by the second account in real time.

The feedback message display module 1250 is also configured to display a real-time acquired picture in response to receiving a selection operation performed on the real-time content option, the real-time acquired picture being a picture which is acquired in real time by the second account by using a multimedia acquisition device and shared to the first account.

In an embodiment, the apparatus further includes a control receiving module 1260 configured to receive a terminal control operation during the displaying the real-time acquired picture; and transmit a control message to the second account on the basis of the terminal control operation, the control message is used for instructing the second account to perform an operation synchronized with the terminal control operation.

In an embodiment, the invitation accept message includes a download option, and the download option is used for providing the first account with an option to download the multimedia data acquired by the second account within a specified time period.

In an embodiment, the control receiving module 1260 is further configured to: receive a first trigger operation performed on the download option; receive a notification message transmitted by the second account; and display the multimedia content acquired by the second account in a message presentation interface in response to a second trigger operation performed on the notification message.

In an embodiment, the message presentation interface also includes a comment region. The control receiving module 1260 is also configured to receive a commenting operation performed on the multimedia content in the comment region.

In an embodiment, the account display module 1230 includes a transmitting unit 1231, an account receiving unit 1232, and an account display unit 1233.

The transmitting unit 1231 is configured to transmit a multimedia interaction request to a server in response to the completion of the configuration operation, the multimedia interaction request includes the acquisition condition.

The account receiving unit 1232 is configured to receive the at least one candidate account fed back by the server on the basis of the acquisition condition.

The account display unit 1233 is configured to display a candidate account list including the at least one candidate account.

In an embodiment, the condition configuration options include condition keywords and filling boxes. The configuration module 1220 is configured to receive, for a filling box corresponding to the condition keyword, a filling operation, as the configuration operation, performed on the filling box.

In an embodiment, the condition configuration options include at least one of a device configuration option, a geographical location configuration option, a time configuration option and a qualification configuration option. The device configuration option is used for indicating a device acquisition condition for acquiring the multimedia content; the geographical location configuration option is used for indicating a geographical location acquisition condition for acquiring the multimedia content; the qualification configuration option is used for indicating a qualification condition of an executive party for acquiring the multimedia content; and the time configuration option is used for indicating a time range condition for acquiring the multimedia content.

In an embodiment, the condition configuration options include the geographical location configuration option.

The configuration module 1220 is further configured to: receive, for a first filling box of the geographical location configuration option, a third trigger operation performed on the first filling box; and display a map preview interface in response to the third trigger operation, receive a positioning operation in the map preview interface, and obtain the geographical location acquisition condition.

In an embodiment, the condition configuration options include the qualification configuration option.

The configuration module 1220 is further configured to: receive, for a second filling box of the qualification configuration option, a fourth trigger operation performed on the second filling box; display a candidate qualification list in response to the fourth trigger operation; and receive a selection operation performed on the candidate qualification list, and obtaining the qualification condition.

In an embodiment, the at least two condition configuration options are displayed in a tilted and parallel manner in the condition configuration interface; or, the at least two condition configuration options are switched to be displayed correspondingly for at least two tabs in the condition configuration interface.

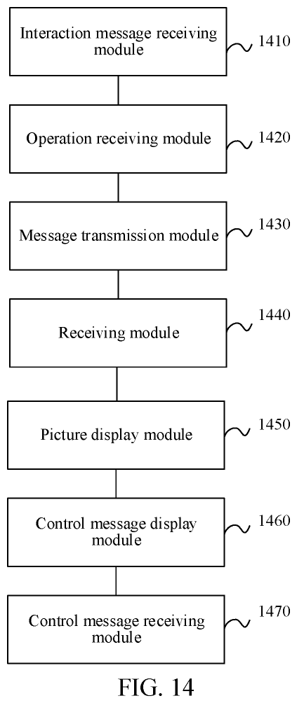

FIG. 14 is a structural block diagram of a multimedia interaction apparatus provided according to another exemplary embodiment of this disclosure. As shown in FIG. 14, the apparatus includes an interaction message receiving module 1410, an operation receiving module 1420, and a message transmission module 1430.

The interaction message receiving module 1410 is configured to receive an interaction message transmitted by a first account, the interaction message includes acquisition conditions configured by the first account for acquiring a multimedia content, and a second account currently logged in is an account satisfying the acquisition conditions.

The operation receiving module 1420 is configured to receive a fifth trigger operation performed on the interaction message.

The message transmission module 1430 is configured to transmit a feedback message to the first account on the basis of the fifth trigger operation, the feedback message is used for indicating an interaction response of the second account to the acquisition of the multimedia content.

In an embodiment, the message transmission module 1430 is configured to: transmit an invitation accept message to the first account in response to receiving an accept operation performed by the second account on the interaction message; or, transmit an invitation reject message to the first account in response to receiving a reject operation performed by the second account on the interaction message.

In an embodiment, the apparatus further includes a receiving module 1440, a picture display module 1450, a control message display module 1460, and a control message receiving module 1470.

The receiving module 1440 is configured to receive a multimedia acquisition operation.

The picture display module 1450 is configured to display an acquired multimedia picture on the basis of the multimedia acquisition operation, the acquired multimedia picture is a real-time displayed picture when the second account performs multimedia acquisition.

The control message display module 1460 is configured to display a prompt message that prompts the first account to view the acquired multimedia picture in real time.

The control message receiving module 1470 is configured to receive a control message transmitted by the first account, the control message is a message transmitted by the first account through a control operation performed on a terminal, and the control message is used for instructing the second account to perform a control operation synchronized with that of the first account.

The multimedia interaction apparatus provided by the above embodiments are only illustrated by dividing the functional modules. In practical applications, the foregoing functions may be allocated to and completed by different functional modules as required, that is, an inner structure of a device is divided into different functional modules, so as to complete all or some of the functions described above. In addition, the multimedia interaction apparatus and the multimedia interaction method provided in the above embodiments belong to the same idea, and specific implementation processes of the apparatus refer to the details in the method embodiments, and are not described here again.

It is noted that the term module (and other similar terms such as unit, submodule, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

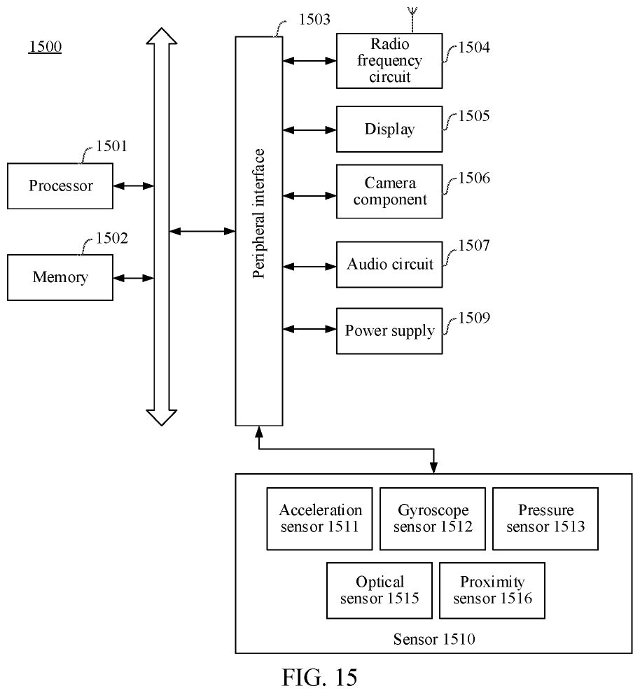

FIG. 15 shows a structural block diagram of an electronic device 1500 according to one exemplary embodiment of this disclosure. The electronic device 1500 may be a portable mobile terminal, such as: a smart phone, a vehicle-mounted terminal, a tablet computer, an MP3 (Moving Picture Experts Group Audio Layer III) player, an MP4 (Moving Picture Experts Group Audio Layer IV) player, a notebook computer or a desktop computer. The electronic device 1500 may also be referred to as a user equipment, a portable terminal, a laptop terminal, a desktop terminal, or other names.

Generally, the electronic device 1500 includes: a processor 1501 and a memory 1502.

Processing circuitry, such as the processor 1501, may include one or more processing cores, for example, a 4-core processor or an 8-core processor.

The memory 1502 may include one or more computer-readable storage media. The computer-readable storage medium may be non-transient. In some embodiments, a non-transitory computer-readable storage medium in the memory 1502 is configured to store at least one instruction, the at least one instruction being used for being executed by the processor 1501 to implement the multimedia interaction methods provided in the method embodiments of this disclosure.

In some embodiments, the electronic device 1500 also includes: a peripheral interface 1503 and at least one peripheral. The processor 1501, the memory 1502, and the peripheral interface 1503 may be connected through a bus or a signal cable. Each peripheral may be connected to the peripheral interface 1503 through a bus, a signal cable, or a circuit board. Specifically, the peripheral includes: at least one of a radio frequency circuit 1504, a display screen 1505, a camera component 1506, an audio circuit 1507, and a power supply 1509.

The peripheral interface 1503 may be configured to connect the at least one peripheral related to input/output (I/O) to the processor 1501 and the memory 1502.

The RF circuit 1504 is configured to receive and transmit an RF signal, also referred to as an electromagnetic signal. The RF circuit 1504 communicates with a communication network and other communication devices through the electromagnetic signal.

The display screen 1505 is configured to display a user interface (UI). The UI may include a graph, text, an icon, a video, and any combination thereof.

The camera component 1506 is configured to capture images or videos.

The audio circuit 1507 may include a microphone and a speaker.

The power supply 1509 is used for supplying power to the various components in the electronic device 1500.

In some embodiments, the electronic device 1500 further includes one or more sensors 1510. The one or more sensors 1510 include but are not limited to: an acceleration sensor 1511, a gyroscope sensor 1512, a pressure sensor 1513, an optical sensor 1515, and a proximity sensor 1516.

It is understood by those skilled in the art that the structure shown in FIG. 15 is not a limitation of the electronic device 1500 and may include more or fewer components than shown, or some components may be combined, or a different arrangement of components may be employed.

The embodiments of this disclosure also provide a computer device that may be implemented as the terminal or server as shown in FIG. 2. The computer device includes a processor and a memory. The memory stores at least one instruction, at least one program, a code set, or an instruction set, and the at least one instruction, the at least one program, the code set, or the instruction set is loaded and executed by the processor to implement the multimedia interaction methods provided in the various method embodiments.

The embodiments of this disclosure also provide a computer-readable storage medium which stores at least one instruction, at least one program, a code set, or an instruction set, and the at least one instruction, the at least one program, the code set, or the instruction set is loaded and executed by a processor to implement the multimedia interaction methods provided in the various method embodiments.

The embodiments of this disclosure further provide a computer program product or a computer program, the computer program product or the computer program including computer instructions stored in a computer-readable storage medium, such as a non-transitory computer-readable storage medium. The processor of the computer device reads the computer instructions from the computer-readable storage medium, and executes the computer instructions, so that the computer device implements any multimedia interaction method in the embodiments of this disclosure.

In some examples, the computer-readable storage medium may include: a Read Only Memory (ROM), a Random Access Memory (RAM), a Solid State Drive (SSD) or an optical disc, and the like. The RAM may include a Resistance Random Access Memory (ReRAM) and a Dynamic Random Access Memory (DRAM). The above-mentioned embodiments of the present disclosure are merely for description, and do not represent the advantages and disadvantages of the embodiments.

What is claimed is:

1. A method of multimedia interaction, comprising:
displaying, by processing circuitry of a first terminal device, a condition configuration interface of an application that is logged in into a first account, the condition configuration interface comprising condition configuration options;
determining an acquisition condition for acquiring a multimedia content in response to a configuration operation performed on the condition configuration options in the condition configuration interface;
displaying at least one candidate account that matches the acquisition condition; and
transmitting an interaction message to a second account in response to a selection operation performed on the second account in the at least one candidate account, the interaction message indicating an invitation from the first account to the second account to acquire the multimedia content.

2. The method according to claim 1, further comprising:
receiving a feedback message from the second account in response to the interaction message.

3. The method according to claim 2, further comprising:
displaying the feedback message that is an invitation accept message indicating that the second account accepts the invitation to acquire the multimedia content; or
displaying the feedback message that is an invitation reject message indicating that the second account rejects the invitation to acquire the multimedia content.

4. The method according to claim 2, wherein the feedback message is an invitation accept message with a real-time content option for providing the first account with multimedia data acquired by the second account in real time, and the method further comprises:
displaying a real-time acquired picture in response to a selection operation performed on the real-time content option, the real-time acquired picture being acquired in real time by a second terminal device with the second account logged in and being shared to the first account.

5. The method according to claim 4, further comprising:
transmitting a control message to the second account in response to a terminal control operation on the first terminal device, the control message instructing the second account to perform an operation corresponding to the terminal control operation on a second terminal device with the second account logged in.

6. The method according to claim 2, wherein:
the feedback message is an invitation accept message with a download option for providing the first account with an option to download multimedia content acquired by the second account within a specified time period.

7. The method according to claim 6, further comprising:
receiving a notification message transmitted by the second account in response to a first trigger operation performed on the download option; and
displaying the multimedia content acquired by the second account in a message presentation interface in response to a second trigger operation performed on the notification message.

8. The method according to claim 7, wherein the message presentation interface comprises a comment region, and the method comprises:
receiving comments to the multimedia content in response to a commenting operation in the comment region.

9. The method according to claim 1, wherein the displaying the at least one candidate account comprises:
transmitting a multimedia interaction request to a server in response to a completion of the configuration operation, the multimedia interaction request comprising the acquisition condition;
receiving the at least one candidate account that is determined by the server based on the acquisition condition; and
displaying a candidate account list comprising the at least one candidate account.

10. The method according to claim 1, wherein the condition configuration options comprise condition keywords and filling boxes respectively corresponding to the condition keywords, and the method further comprises:
obtaining the acquisition condition in response to a filling operation in a filling box corresponding to a condition keyword in the condition keywords.

11. The method according to claim 10, wherein the condition configuration options comprise at least one of a geographical location configuration option, a qualification configuration option, a time configuration option and a device configuration option;
the device configuration option indicates a device acquisition condition for acquiring the multimedia content;
the geographical location configuration option indicates a geographical location acquisition condition for acquiring the multimedia content;
the qualification configuration option indicates a qualification condition of an executive party for acquiring the multimedia content; and
the time configuration option indicates a time range condition for acquiring the multimedia content.

12. The method according to claim 10, wherein the condition configuration options comprise a geographical location configuration option for indicating a geographical location acquisition condition for acquiring the multimedia content; and the method comprises:
displaying a map preview interface in response to a third trigger operation on a first filing box associated with the geographical location configuration option; and
obtaining the geographical location acquisition condition in response to a positioning operation in the map preview interface.

13. The method according to claim 10, wherein the condition configuration options comprise a qualification configuration option for indicating a qualification condition of an executive party for acquiring the multimedia content; and the method comprises:
displaying a candidate qualification list in response to a fourth trigger operation performed on a second filling box associated with the qualification configuration option; and
obtaining the qualification condition in response to a selection operation performed on the candidate qualification list.

14. The method according to claim 1, wherein:
the condition configuration options are displayed in a tilted and parallel manner in the condition configuration interface; or
the condition configuration options are switched to be displayed correspondingly for tabs in the condition configuration interface.

15. A method of multimedia interaction, comprising:
receiving, by processing circuitry of a terminal device that is an executive terminal device for a multimedia acquisition, an interaction message from a first account, the interaction message comprising one or more acquisition conditions configured by the first account for an invitation to acquire a multimedia content, and the terminal device being logged in into a second account that satisfies the one or more acquisition conditions; and
transmitting a feedback message to the first account in response to a fifth trigger operation performed on the interaction message, the feedback message indicating an interaction response of the second account to the invitation to acquire the multimedia content.

16. The method according to claim 15, wherein the transmitting the feedback message to the first account comprises:
transmitting an invitation accept message to the first account in response to an accept operation performed on the interaction message; or
transmitting an invitation reject message to the first account in response to a reject operation performed on the interaction message.

17. The method according to claim 15, further comprising:
displaying an acquired multimedia picture in response to a multimedia acquisition operation, the acquired multimedia picture being a real-time picture acquired by the second account.

18. The method according to claim 17, further comprising:
displaying a prompt message that notifies the acquired multimedia picture being viewed by the first account in real time.

19. The method according to claim 18, further comprising:
receiving a control message from the first account, the control message indicating a control operation performed on an invitation terminal device with the first account logged in, and the control message being used for instructing the second account to perform an operation corresponding to the control operation.

20. An apparatus, comprising processing circuitry configured to:
display a condition configuration interface of an application that is logged in into a first account, the condition configuration interface comprising condition configuration options;
determine an acquisition condition for acquiring a multimedia content in response to a configuration operation performed on the condition configuration options in the condition configuration interface;
display at least one candidate account that matches the acquisition condition; and
transmit an interaction message to a second account in response to a selection operation performed on the second account in the at least one candidate account, the interaction message indicating an invitation from the first account to the second account to acquire the multimedia content.
